(19) United States
(12) Patent Application Publication
(10) Pub. No.: US 2020/0323231 A1
(43) Pub. Date: Oct. 15, 2020

(54) COMPRESSIBLE NON-DAIRY CHEESE ANALOGS, FORMULATIONS AND PROCESSES FOR MAKING SAME

(71) Applicant: Ripple Foods, PBC, Berkeley, CA (US)

(72) Inventors: Michael SCHELLE, San Francisco, CA (US); Sutton COWPERTHWAITE, San Francisco, CA (US); Lance KIZER, Oakland, CA (US); Neil RENNINGER, Peidmont, CA (US)

(73) Assignee: Ripple Foods, PBC, Berkeley, CA (US)

(21) Appl. No.: 16/913,749

(22) Filed: Jun. 26, 2020

Related U.S. Application Data
(63) Continuation of application No. PCT/US2018/067629, filed on Dec. 27, 2018.
(60) Provisional application No. 62/611,258, filed on Dec. 28, 2017.

(51) Int. Cl. A23C 20/02; A23L 29/269

(52) U.S. Cl. CPC A23C 20/02; A23V 2002/00; A23L 29/272

(57) ABSTRACT

Non-dairy cheese analogs and/or semi-soft non-dairy analogs that are derived substantially from or wholly from non-animal sources and have, among other things, improved cohesiveness, compressibility characteristics and/or rupture characteristics. Certain exemplary embodiments are directed to formulations that may be used to produce non-dairy analogs as well as non-dairy cheese analogs comprising high acyl gellan gum. Also provided are processes for production of such non-dairy cheese analogs and formulations.

### CROSS-REFERENCE TO RELATED APPLICATIONS

This application is a continuation of, and claims the benefit under 35 U.S.C. § 120 to, International Application No. PCT/US2018/067629, filed Dec. 27, 2018, which claims priority to U.S. Provisional Patent Application No. 62/611,258 filed on Dec. 28, 2017, and entitled “Compressible Non-Dairy Cheese Analogs, Formulations and Processes for Making Same,” the content of which is hereby incorporated by reference in its entirety.

This application is also related PCT/US2017/012747 filed Jan. 9, 2017, and entitled “Product Analogs or Components of Such Analogs and Processes for Making the Same,” the content of which is hereby incorporated by reference in its entirety.

### FIELD OF THE DISCLOSURE

The present disclosure relates to non-dairy cheese analogs that are derived substantially from or wholly from non-animal sources and have, among other things, improved compressibility characteristics. Certain exemplary embodiments relate to compositions for non-dairy cheese analogs comprising gum, for example, high acyl gellan gum. Also provided are processes for production of such non-dairy cheese analogs.

### BACKGROUND

Vegetarian and vegan diets provide many benefits to consumers. Such benefits include healthy nutrition (e.g., lower saturated fats, no cholesterol), absence of ethical or religious dietary conflicts, less negative environmental impacts (e.g., less greenhouse gases produced in production), more efficient use of resources (e.g., less water used in production), and for consumers who have developed intolerances to certain dairy milk constituents, avoidance of such intolerance.

Semi-soft non-dairy cheese analog products derived from various plants sources are available to consumers. Demand for these vegetarian/vegan alternatives to dairy cheese products is fueled, inter alia, by the factors described herein. However, acceptance of the semi-soft non-dairy cheese substitutes has been relatively low. One of the reasons is that dairy based semi-soft cheeses have a texture and mouthfeel that consumers have come to expect. The texture of semi-soft dairy cheese (e.g., mozzarella) is in part defined by the ability of the cheese to be compressed without rupturing. This property is related to certain physical attributes of the cheese, including slicing, shredding, stringiness and/or mouthfeel. This property is also related to certain physical attributes of the cheese when used, for example, in producing pizza where the cheese used needs to have a moderate toughness, adequate stringiness, as well as it grinds, slices and shreds with minimum matting and while in the oven releases enough oil to envelope other ingredients in the pizza topping while still maintaining suitable shape and stringiness. Despite the usefulness of compressibility without rupture in dairy cheese systems, non-dairy semi-soft cheese analogs are severely deficient in this attribute and typically fracture with minimal compression. This deficiency has an impact on the consumer's reaction to existing non-dairy semi-soft cheese analogs. It has been particularly challenging to create a plant-based semi-soft cheese analog that has suitable physical attributes that the consumer has come to expect in similar semi-soft dairy-based cheeses.

There exists an unmet need for semi-soft non-dairy or substantially non-dairy semi-soft cheese analog products that have suitable (and consumer expected) compression properties. The present disclosure describes exemplary embodiments of formulations and/or plant-based semi-soft cheese analogs that have suitable compression characteristics, as well as processes for their production. The present disclosure is directed to solving these and other problems disclosed herein. The present disclosure is also directed to overcoming and/or ameliorating at least one of the disadvantages of the prior art as will become apparent from the discussion herein. There is a need in the art for a non-dairy cheese analog that may be compressed to high strain without rupturing.

### SUMMARY

Certain exemplary embodiments are to a non-dairy cheese analog comprising: a gelling component wherein the non-dairy cheese analog has a compressibility of between 40% and 100% without rupturing or substantial rupturing.

Certain exemplary embodiments are to a semi-soft non-dairy cheese analog comprising: a gelling component wherein the non-dairy cheese analog has a compressibility of between 40% and 100% without rupturing or substantial rupturing.

Certain exemplary embodiments are to a non-dairy cheese analog comprising: a gum, for example, a high acyl gellan gum wherein the non-dairy cheese analog has a compressibility of between 40% and 100% without rupturing or substantially rupturing.

Certain exemplary embodiments are to a non-dairy cheese analog, wherein the non-dairy cheese analog has a cohesiveness of between 0.55 and 1, an average hardness of between 5 Newton and 45 Newton and a compressibility of between 40% and 100% without rupture or substantial rupture.

Certain exemplary embodiments are to a semi-soft non-dairy cheese analog comprising: a gum, for example, a high acyl gellan gum wherein the non-dairy cheese analog has a compressibility of between 40% and 100% without rupturing or substantially rupturing.

Certain exemplary embodiments are to a non-dairy cheese analog comprising: between 0.2% and 5% by weight of a high acyl gellan gum.

Certain exemplary embodiments are to a semi-soft non-dairy cheese analog comprising: between 0.2% and 5% by weight of a high acyl gellan gum.

Certain exemplary embodiments are to a mozzarella non-dairy cheese analog comprising: between 0.2% and 5% by weight of a high acyl gellan gum.

Certain exemplary embodiments are to a non-dairy cheese analog formulation comprising: between 0.2% and 5% by weight of a high acyl gellan gum.

Certain exemplary embodiments are to a semi-soft non-dairy cheese analog formulation comprising: between 0.2% and 5% by weight of a high acyl gellan gum.

Certain exemplary embodiments are to a mozzarella non-dairy cheese analog formulation comprising: between 0.2% and 5% by weight of a high acyl gellan gum.

Certain exemplary embodiments are a non-dairy cheese analog comprising: between 0.2% and 5% by weight of a high acyl gellan gum and a compressibility of between 40% and 100% without substantial rupturing.

Certain exemplary embodiments are to a mozzarella non-dairy cheese analog comprising: between 0.2% and 5% by weight of a high acyl gellan gum and compressibility of between 40% and 100% without substantial rupturing.

Certain exemplary embodiments are directed to a semi-soft non-dairy cheese analog comprising: a) between 8% to 16% by weight of a plant protein; b) between 8% to 18% of a starch; c) between 8 to 18% by weight of one or more plant oils; and d) between 0.2% to 5% by weight of an high acyl gellan gum, wherein the a semi-soft non-dairy cheese analog has a compressibility of between 40% and 100%.

Certain exemplary embodiments are directed to a semi-soft non-dairy cheese analog comprising: a) between 8% to 16% by weight of a plant protein; b) between 8% to 18% of a starch; c) between 8 to 18% by weight of one or more plant oils; and d) between 0.2% to 5% by weight of an high acyl gellan gum, wherein the semi-soft non-dairy cheese analog has a compressibility of between 40% and 100% without substantial rupturing.

Certain exemplary embodiments are directed to a semi-soft substantially non-dairy cheese analog comprising: a) between 8% to 16% by weight of a plant protein; b) between 8% to 18% of a starch; c) between 8 to 18% by weight of one or more plant oils; and d) between 0.2% to 5% by weight of an high acyl gellan gum, wherein the a semi-soft non-dairy cheese analog has a compressibility of between 40% and 100%.

Certain exemplary embodiments are directed to a semi-soft substantially non-dairy cheese analog comprising: a) between 8% to 16% by weight of a plant protein; b) between 8% to 18% of a starch; c) between 8 to 18% by weight of one or more plant oils; and d) between 0.2% to 5% by weight of an high acyl gellan gum, wherein the semi-soft non-dairy cheese analog has a compressibility of between 40% and 100% without substantial rupturing.

Certain exemplary embodiments are directed to a semi-soft non-dairy cheese analog formulation comprising: a) between 8% to 16% by weight of a plant protein; b) between 8% to 18% of a starch; c) between 8 to 18% by weight of one or more plant oils; and d) between 0.2% to 5% by weight of an high acyl gellan gum, wherein the a semi-soft non-dairy cheese analog has a compressibility of between 40% and 100%.

Certain exemplary embodiments are directed to a semi-soft non-dairy cheese analog formulation comprising: a) between 8% to 16% by weight of a plant protein; b) between 8% to 18% of a starch; c) between 8 to 18% by weight of one or more plant oils; and d) between 0.2% to 5% by weight of an high acyl gellan gum, wherein the semi-soft non-dairy cheese analog has a compressibility of between 40% and 100% without substantial rupturing.

Certain exemplary embodiments are directed to a semi-soft substantially non-dairy cheese analog formulation comprising: a) between 8% to 16% by weight of a plant protein; b) between 8% to 18% of a starch; c) between 8 to 18% by weight of one or more plant oils; and d) between 0.2% to 5% by weight of an high acyl gellan gum, wherein the a semi-soft non-dairy cheese analog has a compressibility of between 40% and 100%.

Certain exemplary embodiments are directed to a semi-soft substantially non-dairy cheese analog formulation comprising: a) between 8% to 16% by weight of a plant protein; b) between 8% to 18% of a starch; c) between 8 to 18% by weight of one or more plant oils; and d) between 0.2% to 5% by weight of an high acyl gellan gum, wherein the semi-soft non-dairy cheese analog has a compressibility of between 40% and 100% without substantial rupturing.

Certain exemplary embodiments are directed to a semi-soft non-dairy cheese analog comprising: a) between 15% to 30% of a starch; b) between 10 to 20% by weight of one or more plant oils; and c) between 0.2% to 5% by weight of a high acyl gellan gum, wherein the semi-soft non-dairy cheese analog has a compressibility of between 40% and 100% without substantial rupturing.

Certain exemplary embodiments are directed to a semi-soft substantially non-dairy cheese analog comprising: a) between 15% to 30% of a starch; b) between 10 to 20% by weight of one or more plant oils; and c) between 0.2% to 5% by weight of a high acyl gellan gum, wherein the semi-soft non-dairy cheese analog has a compressibility of between 40% and 100% without substantial rupturing.

Certain exemplary embodiments are directed to a semi-soft non-dairy cheese analog formulation comprising: a) between 15% to 30% of a starch; b) between 10 to 20% by weight of one or more plant oils; and c) between 0.2% to 5% by weight of a high acyl gellan gum, wherein the semi-soft non-dairy cheese analog has a compressibility of between 40% and 100% without substantial rupturing.

Certain exemplary embodiments are directed to a semi-soft substantially non-dairy cheese analog formulation comprising: a) between 15% to 30% of a starch; b) between 10 to 20% by weight of one or more plant oils; and c) between 0.2% to 5% by weight of a high acyl gellan gum, wherein the semi-soft non-dairy cheese analog has a compressibility of between 40% and 100% without substantial rupturing.

Certain exemplary embodiments are to methods of making a non-dairy cheese analog. Certain exemplary embodiments are to methods of making a semi-soft non-dairy cheese analog. Certain exemplary embodiments are to methods of making a mozzarella non-dairy cheese analog. Certain exemplary embodiments are to methods of making a non-dairy cheese analog formulation. Certain exemplary embodiments are to methods of making a semi-soft non-dairy cheese analog formulation. Certain exemplary embodiments are to methods of making a mozzarella non-dairy cheese analog formulation.

As well as the embodiments discussed in the summary, other embodiments are disclosed in the specification, drawings and claims. The summary is not meant to cover each and every embodiment; combination or variations are contemplated with the present disclosure.

### BRIEF DESCRIPTION OF THE DRAWINGS

Embodiments of the present disclosure are described, by way of example only, with reference to the accompanying figures.

FIG. 1 shows the texture analysis of dairy and non-dairy cheeses. Semi-soft dairy mozzarella cheese (diamond). Daiya non-dairy cheese (plus). Non-dairy cheese analog (circle), according to certain exemplary embodiments.

FIG. 2 shows a representative structure of high acyl gellan gum that may vary depending on the source of the polymer and the processing it has been exposed too.

FIG. 3 shows the range of hardness and strain seen via the rupture test, according to certain exemplary embodiments.

FIG. 4 shows the range of cycle one hardness and cohesiveness seen via the TPA tests performed, according to certain exemplary embodiments.

FIG. 5 shows the range of hardness and strain seen via the rupture test, according to certain exemplary embodiments.

FIG. 6 shows the range of cycle one hardness and cohesiveness seen via the TPA tests performed, according to certain exemplary embodiments.

FIG. 7 shows the range of hardness and strain seen via the rupture test, according to certain exemplary embodiments.

FIG. 8 shows the range of cycle one hardness and cohesiveness seen via the TPA tests performed, according to certain exemplary embodiments.

FIG. 9 shows the range of hardness and strain seen via the rupture test, according to certain exemplary embodiments.

FIG. 10 shows the range of cycle one hardness and cohesiveness seen via the TPA tests performed, according to certain exemplary embodiments.

FIG. 11 shows the range of hardness and strain seen via the rupture test, according to certain exemplary embodiments.

FIG. 12 shows the range of cycle one hardness and cohesiveness seen via the TPA tests performed, according to certain exemplary embodiments.

FIG. 13 shows the range of hardness and strain seen via the rupture test, according to certain exemplary embodiments.

FIG. 14 shows the range of cycle one hardness and cohesiveness seen via the TPA tests performed, according to certain exemplary embodiments.

FIG. 15 shows the range of hardness and strain seen via the rupture test, according to certain exemplary embodiments.

FIG. 16 shows the range of cycle one hardness and cohesiveness seen via the TPA tests performed, according to certain exemplary embodiments.

### DETAILED DESCRIPTION

The present disclosure is described in further detail with reference to one or more embodiments, some examples of which are illustrated in the accompanying drawings. The examples and embodiments are provided by way of explanation and are not to be taken as limiting to the scope of the disclosure. Furthermore, features illustrated or described as part of one embodiment may be used by themselves to provide other embodiments and features illustrated or described as part of one embodiment that may be used with one or more other embodiments to provide further embodiments. The present disclosure covers these variations and embodiments as well as other variations and/or modifications.

The term “average strain” as used herein refers to the change in length in an axial direction divided by the total length of the system in that axial direction.

The term “cheese analog” as used herein is a cheese type product that is derived substantially from or wholly from non-animal sources.

The term “semi-soft cheese analog” refers to an analog that resembles comparable dairy semi-soft cheese and has suitable compression properties. Exemplary types of non-dairy semi-soft cheese analogs are blue cheese, Colby, Fontina styles, Havarti, Mozzarella or Monterey jack.

As used in this disclosure “cheese analog” is understood to be applicable to: non-dairy cheese analogs, substantial non-dairy cheese analogs, non-dairy semi-soft cheese analogs and/or substantially non-dairy semi-soft cheese analogs unless otherwise indicated by the context of the use of the term.

The term “cheese analog formulation” refers to a formulation that may be used to produce a cheese analog. The term “semi-soft cheese analog formulation” refers to a formulation that may be used to produce a semi-soft cheese analog. As used in this disclosure “cheese analog formulation” is understood to be applicable to: non-dairy cheese analog formulations, substantial non-dairy cheese analog formulations, non-dairy semi-soft cheese analog formulations and/or substantially non-dairy semi-soft cheese analog formulations unless otherwise indicated by the context of the use of the term.

The term “cohesiveness” as used herein refers to a measure of the strength of internal bonds making up the body of the product and tendency of cheese to remain together, and resist breaking into several pieces, during compression. This means the ability for the system to reform, after force is exerted on it, into its original shape. This may be calculated as the work done by the second compression divided by the work done by the first compression during texture analysis.

The term “compressibility” as used herein is determined to be the peak strain of the system as a percentage. This may be calculated as average strain multiplied by one hundred percent.

The term “hardness” as used herein refers to the force required to achieve a given deformation. This mean the force needed to compress a system certain distance or to its rupture point. This is may be determined as the maximum and/or peak force exerted on the testing system, such as the CT3 Texture Analyzer, by the system.

The term “high acyl gellan gum” as used herein is a polymer comprising various monosaccharides linked together to form a linear primary structure and the gum gels at temperatures of greater than 60° C. In some high acyl gellan gums, the gel temperature may be approximately 70° C. or greater. In some high acyl gellan gums, the gel temperature may be approximately between 70° C. and 80° C. The properties of the high acyl gellan gum polymer may vary depending at least in part on its source, how it was processed, and/or the number and type of acyl groups present on the polymer.

The term “non-dairy” as used in the present disclosure means that the product or formulation has no dairy-based ingredients or less than 0.5% by weight of dairy-based ingredients. The term “substantially non-dairy” as used in the present disclosure means that the product or formulation has less than 5% by weight of dairy-based ingredients.

The term “rupture” as used herein refers to the material incurring a substantial break or burst under compression and is comparable to fracture, crack, fissure, breach, burst, or split. Not included is insubstantial breaks or bursts that may occur when handling and/or testing the material.

The term “comprise” and its derivatives (e.g., comprises, comprising) as used in this specification is to be taken to be inclusive of features to which it refers, and is not meant to exclude the presence of additional features unless otherwise stated or implied.

As used in this application, the singular form “a,” “an” and “the” include plural references unless the context clearly dictates otherwise.

The features disclosed in this specification (including accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

The subject headings used in the detailed description are included for the ease of reference of the reader and should not be used to limit the subject matter found throughout the disclosure or the claims. The subject headings should not be used in construing the scope of the claims or the claim limitations.

Exemplary non-dairy cheese analogs (or substantially non-dairy cheese analogs) may be prepared by blending water; plant protein and/or starch; a plant-based oil; sugar; and high acyl gellan gum at an elevated temperature and then allowing the blended formulation to set for a period of time at room temperature or below. This process may also be used to prepare non-dairy semi-soft cheese analogs or substantially non-dairy semi-soft cheese analogs.

Exemplary non-dairy cheese analogs (or substantially non-dairy cheese analogs) may be prepared by blending water; starch; a plant-based oil; sugar; and high acyl gellan gum at an elevated temperature and then allowing the blended formulation to set for a period of time at room temperature or below. This process may also be used to prepare non-dairy semi-soft cheese analogs or substantially non-dairy semi-soft cheese analogs.

Exemplary cheese analog formulations and/or cheese analogs may use a single-plant protein or they may come from combining multiple plants proteins. In some exemplary embodiments, the plant protein may be substituted with a starch and the amount of plant protein used may be substantially reduced or eliminated. In some embodiments, the cheese analog formulations and/or cheese analogs may also comprise one or more of the following: plant-based fats, plant based oils, thickening agents, sugar, sweetening agents, emulsifiers, natural flavors, artificial flavors, enzymes, salts, cultures, certified colors and vitamins.

High Acyl Gellan Gum

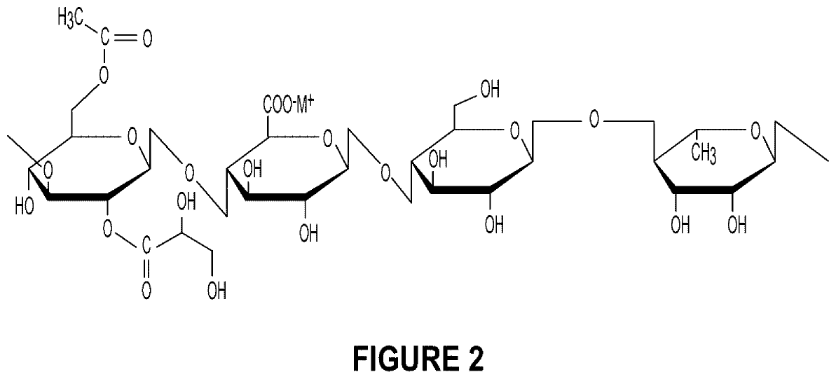

Gellan gum is a gel-forming polysaccharide produced by the microbe Sphingomonas elodea. There are several sources of suitable high acyl gellan gums, for example, Ticagel Gellan HS, TIC gums, KELCOGEL High Acyl Gellan Gum, CP Kelco, Gellan Gum LT100 and Modernist Pantry. Gellan polymers typically consist of monosaccharides beta-d-glucose, beta-d-glucuronic acid and alpha-1-rhamnose in approximate molar ratios of 2:1:1 linked together to form a linear primary structure (FIG. 2). FIG. 2 shows a representative structure that may vary depending on the source of the polymer and the processing it has been exposed to. High acyl gellan solutions typically gel at higher temperatures than low acyl gellan solutions. High acyl gellan gels typically are non-brittle and/or elastic. The present disclosure contemplates that in certain exemplary applications the properties of the high acyl gellan gums may be modified by altering the structure of the polymer, altering the structure of the reactive groups of the polymer, combining high acyl gellan gum with other forms of gellan gum or combinations thereof. As already noted, some variability in the properties of the gellan gums may be found between sources that may be due to the source and/or how the gum was engineered for certain properties. For example, a typical high acyl gellan gum may have the following properties: hydrates at 85° C., gels from 70-80° C., melts from 71-75° C. However, variations in the hydrates, gels and melt properties may occur.

In certain exemplary embodiments, the high acyl gellan gum may comprise on a percent weight basis at least 80, 85, 90, 95, 98, 99 or 99.5% of high acyl gellan gum. In certain exemplary embodiments, the high acyl gellan gum may comprise on a percent weight basis not less than 80, 85, 90, 95, 98, 99, 99.5 or 100% high acyl gellan gum.

In certain exemplary embodiments, the high acyl gellan gum may between 0.2 to 5%, 0.8 to 1.6%, 0.9 to 1.2%, 1.4 to 1.6%, 1.5 to 3% or 2 to 4% of the total weight of the cheese analog formulation and/or cheese analog. In certain exemplary embodiments, the high acyl gellan gum may between 0.2 to 5%, 0.8 to 1.6%, 0.9 to 1.2%, 1.4 to 1.6%, 1.5 to 3% or 2 to 4% of the total weight of the semi-soft non-dairy cheese analog formulation and/or semi-soft non-dairy cheese analog. In certain exemplary embodiments, the high acyl gellan gum may between 0.2 to 5%, 0.8 to 1.6%, 0.9 to 1.2%, 1.4 to 1.6%, 1.5 to 3% or 2 to 4% of the total weight of the semi-soft substantially non-dairy cheese analog formulation and/or semi-soft substantially non-dairy cheese analog.

Other Components

Various plant proteins may be used, including melon, barley, coconut, rice, pear, emmer, carrot, lupin seeds, pea, fennel, lettuce, oat, cabbage, celery, soybeans, almond, rice, flax, potato, sunflower, mushroom, or combinations thereof. In certain exemplary embodiments, pea proteins may be used. Of course, other suitable plant protein isolates are also acceptable.

In some embodiments, the amount of plant protein may comprise at least about 10% by weight of the cheese analog formulation and/or cheese analog; in some embodiments the amount of plant protein may comprise at least about 12% by weight of the cheese analog formulation and/or cheese analog; in some embodiments, the amount of plant protein may comprise at least about 15% by weight of the cheese analog formulation and/or cheese analog; and in some embodiments, it may comprise at least about 18% by weight of the cheese analog formulation and/or cheese analog. In some embodiments, the amount of plant protein may be, about 10, 11, 12, 13, 14, 15, 16, 17, 18, 19 20, 21, 22, 23, 24, 25 or 26% of the weight of the cheese analog formulation and/or cheese analog. In some embodiments, the amount of plant protein may be, between 10-30%, 10-16%, 12-14%, 8-16%, or 12-18% of the weight of the cheese analog formulation and/or cheese analog.

Different flavors may be used. Some exemplary ones include: cheddar cheese flavor, mozzarella cheese flavor, butter flavor, cultured flavor, blue cheese flavor, aged cheddar flavor, sweet cream flavor, cream cheese flavor, dairy flavor, butyric flavor, or combinations of flavors and so forth.

Different thickening agents may be used, including gelatin, pectin, agar, gums, starches, and ultra-gel. Examples of acceptable gums include sodium alginate, xanthan gum, guar gum, locust bean gum, or combinations thereof.

Different fatty materials may be used. Some exemplary fatty materials include coconut oil, coconut cream, palm oil, canola oil, soybean oil or combinations thereof. Other plant based fatty materials are also contemplated.

Different oils may be used, including corn oil, sunflower oil, cottonseed oil, peanut oil, coconut oil, soybean oil, other similar oils or combinations thereof. In some embodiments, the oil may be a combination of coconut oil and sunflower oil. In some embodiments, the oil may be a palm oil. In some embodiments, the percentage of oil added may be between about 5 and 25% by weight. In other embodiments, the percentage may be between about 8 and 18% by weight. In other embodiments, the percentage may be between about 12 and 18% by weight. In other embodiments, the percentage of oil added may be between about 10 and 16%. In other embodiments, the percentage of oil added may be between about 14 and 17%. In other embodiments, the percentage may be between about 15 and 17% by weight. In some embodiments, the percentage may be, about at least 5, 7, 9, 11, 13, 14, 15, 16, 17, 18, 19, 20, 22, 24, 26 or 28% by weight.

Different starches may be used including rice, maize, potatoes, cassava, arrowroot, arracacha, canna, millet, sago, sorghum, taro root, tapioca, sweet potatoes, rye, yams, favas, lentils, mung beans, peas, and chickpeas. Modified starches of the above starches and others are also contemplated. Other plant-based starches are also contemplated. In some embodiments, the percentage of starch added may be between about 10 and 25% by weight. In other embodiments the percentage may be between about 8 and 16% by weight. In other embodiments the percentage may be between about 12 and 18% by weight. In other embodiments, the percentage of starch added may be between about 10 and 14%. In other embodiments, the percentage of starch added may be between about 18 and 24%. In some embodiments the percentage may be, about at least 8, 10, 12, 14, 16, 18, 20, 22, 24, 26 or 28% by weight.

Different sweetening materials may be used, including sugar, honey, glucose, invert sugar, dextrose, or combinations thereof. In some embodiments, cane sugar is used. In some embodiments, the amount of sweetening materials may be at least about 0.5, 1, 1.5, 2, 2.5, 3, 3.5, 4, 4.5, 5 or 5.5% by weight of the cheese analog formulation and/or cheese analog.

Different emulsifiers may be used, including various lecithins, such as egg yolk emulsifying lecithin, sunflower lecithin, and soy lecithin, honey, CSL calcium stearoyl di-laciate, polyglycerol ester, sorbitan ester, PG ester, sugar ester, monoglyceride, acetylated monoglyceride, lactylated monoglyceride or combinations thereof. In some embodiments, the amount of emulsifier may be about between about 0.01 and 1% of the weight of the cheese analog and/or cheese analog. In some embodiments, the amount of emulsifier may be about 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, or 0.2% of the weight of the cheese analog formulation and/or cheese analog.

In some embodiments, probiotic bacteria may also be added.

Methods for Producing Refined Protein Components

Various methods may be used for obtaining refined protein components from non-animal natural sources. The methods disclosed herein have the advantage of removing, or substantially removing, flavoring agents, aroma agents, coloring agents, other agents or combinations thereof from refined protein preparations, and thus make the refined protein preparations more suitable for use in non-dairy analogs. Removal of such agents may also increase the shelf life of non-dairy analogs comprising such refined protein components.

The methods provided herein for obtaining refined protein components from non-animal natural sources may comprise one or more of the following steps, in or out of order:

a. obtaining a protein preparation from a non-animal natural source;

b. washing the protein preparation at a wash pH;

c. extracting the protein preparation at an extraction pH to obtain an aqueous protein solution;

d. separating the aqueous protein solution from non-aqueous components;

e. adding salt;

f. precipitating the protein from the aqueous protein solution at a precipitation pill to obtain a protein precipitate;

g. separating the protein precipitate from non-precipitated components; and

h. washing the protein precipitate to obtain a refined protein component.

The refined protein preparation obtained from a natural source may have various forms, including, but not limited to, protein concentrate, protein isolate, flour, protein meal; native, denatured, or renatured protein; dried; spray dried, or not dried protein; enzymatically treated or untreated protein; and combinations thereof. It may consist of particles of one or more sizes, and may be pure or mixed with other components (e.g., other plant source components). The refined protein preparation may be derived from non-animal natural sources, or from multiple natural sources. In some embodiments, the refined protein preparation is obtained from a plant. In some such embodiments, the plant is legume. In some such embodiments, the legume is pea. The pea may be whole pea or a component of pea, standard pea (i.e., non-genetically modified pea), commoditized pea, genetically modified pea, or combinations thereof. In some embodiments, the pea is Pisum sativum. In some embodiments, the legume is soy. The soy may be whole soy or a component of soy, standard soy (i.e., non-genetically modified soy), commoditized soy, genetically modified soy, or combinations thereof in some embodiments, the legume is chickpea. The chickpea may be whole chickpea or a component of chickpea, standard chickpea (i.e., non-genetically modified chickpea), commoditized chickpea, genetically modified chickpea, or combinations thereof. In some embodiments, the refined protein preparation may be pre-treated for various purposes, such as, for example, extracting the protein preparation in a solvent to remove lipids, and heat treating the protein preparation to remove volatiles.

Washing the refined protein preparation may utilize various methods, including single wash, multiple washes, and/or counter-current washes.

The wash and extraction pH may be a pH that is suitable for washing and solubilizing proteins in a protein preparation. A suitable wash and extraction pH may be determined by testing various pH conditions, and identifying the pH condition at which the most optimal yield and quality (judged by, for example by one or more of the following: flavor, odor, color, nitrogen content, calcium content, heavy metal content, emulsification activity, molecular weight distribution, and thermal properties of the protein component obtained) of the refined protein component is obtained. In some embodiments, the wash and extraction pH are alkaline pH. In some such embodiments, the alkaline pH is at least 7.1, at least 8, at least 9, at least 10, at least 11, at least 12, between 7.1 and 10, between 8 and 10, between 9 and 10, or between 8 and 9. In some such embodiments, the alkaline pH is 8.5. In some embodiments, the wash and extraction are acidic pH. In some such embodiments, the acidic pH is less than 7, less than 6.95, less than 6.5, less than 5, less than 4, less than 3, between 2 and 6.95, between 3 and 6, or between 3 and 5. The extraction pH may be adjusted using a pH adjusting agent. In some embodiments, the pH adjusting agent is a food grade basic pH adjusting agent. In other embodiments, the pH adjusting agent is a food grade acidic pH adjusting agents. Examples of suitable acidic pH adjusting agents include, but are not limited to, phosphoric acid, acetic acid, hydrochloric acid, citric acid, succinic acid, and combinations thereof. Examples of suitable basic pH adjusting agents include, but are not limited to, potassium bicarbonate, sodium bicarbonate, sodium hydroxide, potassium hydroxide, calcium hydroxide, ethanolamine, calcium bicarbonate, calcium hydroxide, ferrous hydroxide, lime, calcium carbonate, trisodium phosphate, and combinations thereof. It is useful to obtain substantially as much extracted protein as is practicable so as to provide an overall high product yield. The yield of protein in the aqueous protein solution may widely, wherein typical yields range from 1% to 90%. The aqueous protein solution typically has a protein concentration of between 1 and 300 g/L. The molecular weight distribution of the proteins comprised in the aqueous protein solution may vary widely.

Separating the aqueous protein solution from non-aqueous components may be accomplished by various methods, including but not limited to, centrifugation followed by decanting of the supernatant above the pellet, or centrifugation in a decanter centrifuge. The centrifugation may be followed by disc centrifugation and/or filtration (e.g., using activated carbon) to remove residual protein source material and/or other impurities. The separation step may be conducted at various temperatures within the range of 1° C. to 100° C. For example, the separation step may be conducted between 10° C. and 80° C., between 15° C. and 70° C. between 20° C. and 60° C., or between 25° C. and 45° C. The non-aqueous components may be re-extracted with fresh solute at the extraction pH, and the protein obtained upon clarification combined with the initial protein solution for further processing as described herein. The separated aqueous protein solution may be diluted or concentrated prior to further processing. Dilution is usually affected using water, although other diluents may be used. Concentration may be affected by membrane-based methods. In some embodiments, the diluted or concentrated aqueous protein solution comprises between 1 g/L and 300 g/L, between 5 g/L and 250 g/L, between 10 g/L and 200 g/L, between 15 g/L and 150 g/L, between 20 g/L and 100 g/L, or between 30 g/L and 70 g/L by weight of protein.

The protein in the aqueous protein solution may be optionally concentrated and/or separated from small, soluble molecules. Suitable methods for concentrating include, but are not limited to, diafiltration or hydrocyclone. Suitable methods for separation from small, soluble molecules include, but are not limited to, diafiltration.

Salt precipitation may be accomplished using various suitable salts and precipitation pHs. Suitable salts, salt concentrations, polysaccharides, polysaccharide concentrations, and precipitation pHs may be determined by testing various conditions, and identifying the salt and pH and polysaccharide condition which are obtained the most colorless and/or flavorless protein precipitates at the most optimal yield and quality (judged by, for example, by one or more of the following: flavor, odor, color, nitrogen content, calcium content, heavy metal content, emulsification activity, molecular weight distribution, and thermal properties of the protein component obtained). In some embodiments, salt precipitation occurs with calcium dichloride at a concentration of between 5 mM and 1,000 mM. Other examples of suitable salts include, but are not limited to, other alkaline earth metal or divalent salts (e.g., magnesium chloride, sodium chloride, calcium permanganate, and calcium nitrate). Typically, the precipitation pH is opposite the extraction pH (i.e., when the extraction pH is in the basic range, the precipitation pH is most suitable in the acidic range, and vice versa). In some embodiments, the precipitation pH is an acidic pH. In some such embodiments, the acidic pH is less than 7.1, less than 6, less than 5, less than 4, less than 3, less than 2, between 6.9 and 2, between 6 and 3, between 6 and 5, or between 5 and 4. In some such embodiments, the acidic pH is 5.25. The precipitation pH may be adjusted using a pH adjusting agent. In some embodiments, the pH adjusting agent is a food grade acidic pH adjusting agent. In other embodiments, the pH adjusting agent is a food grade basic pH adjusting agent.

Separating the protein precipitate from non-precipitated components may occur by one or more of the methods disclosed herein.

Washing of the protein precipitate may occur by various methods. In some embodiments, the washing is carried out at the precipitation pH.

The protein precipitate may optionally be suspended. In some embodiments, the suspending is carried out at the extraction pH, for example, in the presence of a chelator to remove calcium ions. If the suspended protein preparation is not transparent it may be clarified by various convenient procedures such as filtration or centrifugation.

The pH of the suspended color-neutral refined protein component may be adjusted to a of between 1 and 14, between 2 and 12, between 4 and 10, or between 5 and 7, by the addition of a food grade basic pH adjusting agent, including, for example, sodium hydroxide, or food grade acidic pH adjusting agent, including, for example, hydrochloric acid or phosphoric acid.

The pH of the refined protein component and/or refined protein isolate may be adjusted to a pH of between 1 and 14, between 2 and 12, between 4 and 10, or between 5 and 7, by the addition of a food grade basic pH adjusting agent, including, for example, sodium hydroxide, or food grade acidic pH adjusting agent, including, for example, hydrochloric acid or phosphoric acid.

The refined protein component may be dried. Drying may be performed in a suitable way, including, but not limited to, spray drying, dry mixing, agglomerating, freeze drying, microwave drying, drying with ethanol, evaporation, refractory window dehydration or combinations thereof.

The refined protein component and/or refined protein isolate may be dried. Drying may be performed in a suitable way, including, but not limited to, spray drying, dry mixing, agglomerating, freeze drying, microwave drying, drying with ethanol, evaporation, refractory window dehydration or combinations thereof.

Other optional steps in the exemplary methods are heating steps aimed at removing heat-labile contaminants and/or microbial contaminations, and additional filtering (e.g., carbon filtering) steps aimed at removing additional odor, flavor, and/or color compounds. In some embodiments, such additional filtering is carried out immediately after extracting the protein preparation or after separating the aqueous protein solution from the non-aqueous components.

Rheology and Texture

The cheese analogs in the present disclosure may be usefully characterized by their compressibility and/or their compressibility without rupture or substantial rupture. The rheology of cheese analogs is related at least in part to their stress deformation and may be characterized at least in part using compression testing. In practice, such stresses are applied to cheese during processing (e.g., portioning, slicing, shredding and grating) and consumption (slicing, spreading, and chewing). Compressibility measurements on exemplary cheese analogs may be conducted using uniaxial compression methodologies. For example, a CT3 Texture Analyzer (Brookfield Engineering) as discussed in Example 1 may be used to characterize certain exemplary embodiments' compressibility and/or their compressibility without rupture or substantial rupture.

Certain exemplary embodiments are to a non-dairy cheese analog comprising: a gelling component wherein the non-dairy cheese analog has a compressibility of between 40% and 100%, between 55% to 60%, between 50% and 80%, between 40% to 60% or between 60% to 90%. Certain exemplary embodiments are to a non-dairy cheese analog comprising: a gelling component wherein the non-dairy cheese analog has a compressibility of approximately 60% or at least 40%, 50%, 55%, 60%, 65% or 70%. Certain exemplary embodiments are to a non-dairy cheese analog comprising: a gelling component wherein the non-dairy cheese analog has a compressibility of between 40% and 100%, between 55% to 60%, between 50% and 80%, between 40% to 60% or between 60% to 90% without rupture or substantial rupture. Certain exemplary embodiments are to a non-dairy cheese analog comprising: a gelling component wherein the non-dairy cheese analog has a compressibility of approximately 60% or at least 40%, 50%, 55%, 60%, 65% or 70% without rupture or substantial rupture. Certain exemplary embodiments are to a non-dairy cheese analog comprising: a gelling component wherein the non-dairy cheese analog has a compressibility of between 40% and 100%, between 55% to 60%, between 50% and 80%, between 40% to 60% or between 60% to 90% without substantial rupture when tested using the following test parameters: CT3 Texture Analyzer; cylinder same sample 10 mm in length and 12 mm in diameter, sample temperature 25° C., rupture test, stop at load, 0.5 mm/sec test speed, 1 N trigger load and probe TA4/1000. In certain exemplary embodiments, the non-dairy cheese analog may be a substantially non-dairy cheese analog. Certain exemplary embodiments are to a non-dairy cheese analog comprising: a gelling component wherein the non-dairy cheese analog has a compressibility of approximately 60% or at least 40%, 50%, 55%, 60%, 65% or 70% without substantial rupture when tested using the following test parameters: CT3 Texture Analyzer; cylinder same sample 10 mm in length and 12 mm in diameter, sample temperature 25° C., rupture test, stop at load, 0.5 mm/sec test speed, 1 N trigger load and probe TA4/1000. In certain exemplary embodiments, the non-dairy cheese analog may be a substantially non-dairy cheese analog.

Certain exemplary embodiments are to a non-dairy semi-soft cheese analog comprising: a gelling component wherein the non-dairy cheese analog has a compressibility of between 40% and 100%, between 55% to 60%, between 50% and 80%, between 40% to 60% or between 60% to 90%. Certain exemplary embodiments are to a non-dairy semi-soft cheese analog comprising: a gelling component wherein the non-dairy cheese analog has a compressibility of approximately 60% or at least 40%, 50%, 55%, 60%, 65% or 70%. Certain exemplary embodiments are to a non-dairy semi-soft cheese analog comprising: a gelling component wherein the non-dairy cheese analog has a compressibility of between 40% and 100%, between 55% to 60%, between 50% and 80%, between 40% to 60% or between 60% to 90% without rupture or substantial rupture. Certain exemplary embodiments are to a non-dairy semi-soft cheese analog comprising: a gelling component wherein the non-dairy cheese analog has a compressibility of approximately 60% or at least 40%, 50%, 55%, 60%, 65% or 70% without rupture or substantial rupture. Certain exemplary embodiments are to a non-dairy semi-soft cheese analog comprising: a gelling component wherein the non-dairy cheese analog has a compressibility of between 40% and 100%, between 55% to 60%, between 50% and 80%, between 40% to 60% or between 60% to 90% without substantial rupture when tested using the following test parameters: CT3 Texture Analyzer; cylinder same sample 10 mm in length and 12 mm in diameter, sample temperature 25° C., rupture test, stop at load, 0.5 mm/sec test speed, 1 N trigger load and probe TA4/1000. Certain exemplary embodiments are to a non-dairy semi-soft cheese analog comprising: a gelling component wherein the non-dairy cheese analog has a compressibility of approximately 60% or at least 40%, 50%, 55%, 60%, 65% or 70% without substantial rupture when tested using the following test parameters: CT3 Texture Analyzer; cylinder same sample 10 mm in length and 12 mm in diameter, sample temperature 25° C., rupture test, stop at load, 0.5 mm/sec test speed, 1 N trigger load and probe TA4/1000. In certain exemplary embodiments, the non-dairy semi-soft cheese analog may be a substantially non-dairy semi-soft cheese analog.

Certain exemplary embodiments are to a non-dairy cheese analog comprising: a gelling component wherein the non-dairy cheese analog has a cohesiveness of between 0.55 and 1, between 0.6 to 1, between 0.7 and 1, or between 0.7 to 0.9. Certain exemplary embodiments are to a non-dairy cheese analog comprising: a gelling component wherein the non-dairy cheese analog has a cohesiveness of approximately 0.8 or at least 0.5, 0.6, 0.65, 0.75, 0.8. Certain exemplary embodiments are to a non-dairy cheese analog comprising: a gelling component wherein the non-dairy cheese analog has a cohesiveness between 0.55 and 1, between 0.6 to 1, between 0.7 and 1, or between 0.7 to 0.9 without rupture or substantial rupture. Certain exemplary embodiments are to a non-dairy cheese analog comprising: a gelling component wherein the non-dairy cheese analog has a cohesiveness approximately 0.8 or at least 0.5, 0.6, 0.65, 0.75, 0.8 without rupture or substantial rupture. Certain exemplary embodiments are to a non-dairy cheese analog comprising: a gelling component wherein the non-dairy cheese analog has a cohesiveness of between 0.55 and 1, between 0.6 to 1, between 0.7 and 1, or between 0.7 to 0.9 without substantial rupture when tested using the following test parameters: CT3 Texture Analyzer; cylinder same sample 10 mm in length and 12 mm in diameter, sample temperature 25° C., rupture test, stop at load, 0.5 mm/sec test speed, 1 N trigger load and probe TA4/1000. In certain exemplary embodiments, the non-dairy cheese analog may be a substantially non-dairy cheese analog. Certain exemplary embodiments are to a non-dairy cheese analog comprising: a gelling component wherein the non-dairy cheese analog has a cohesiveness of approximately 0.8 or at least 0.5, 0.6, 0.65, 0.75, 0.8 without substantial rupture when tested using the following test parameters: CT3 Texture Analyzer; cylinder same sample 10 mm in length and 12 mm in diameter, sample temperature 25° C., rupture test, stop at load, 0.5 mm/sec test speed, 1 N trigger load and probe TA4/1000. In certain exemplary embodiments, the non-dairy cheese analog may be a substantially non-dairy cheese analog.

Certain exemplary embodiments are to a non-dairy semi-soft cheese analog comprising: a gelling component wherein the non-dairy cheese analog has a cohesiveness of between 0.55 and 1, between 0.6 to 1, between 0.7 and 1, or between 0.7 to 0.9. Certain exemplary embodiments are to a non-dairy semi-soft cheese analog comprising: a gelling component wherein the non-dairy cheese analog has a cohesiveness of approximately 0.8 or at least 0.5, 0.6, 0.65, 0.75, or 0.8. Certain exemplary embodiments are to a non-dairy semi-soft cheese analog comprising: a gelling component wherein the non-dairy cheese analog has a cohesiveness of between 0.55 and 1, between 0.6 to 1, between 0.7 and 1, or between 0.7 to 0.9 without rupture or substantial rupture. Certain exemplary embodiments are to a non-dairy semi-soft cheese analog comprising: a gelling component wherein the non-dairy cheese analog has a cohesiveness approximately 0.8 or at least 0.5, 0.6, 0.65, 0.75, or 0.8 without rupture or substantial rupture. Certain exemplary embodiments are to a non-dairy semi-soft cheese analog comprising: a gelling component wherein the non-dairy cheese analog has a cohesiveness of between 0.55 and 1, between 0.6 to 1, between 0.7 and 1, or between 0.7 to 0.9 without substantial rupture when tested using the following test parameters: CT3 Texture Analyzer; cylinder same sample 10 mm in length and 12 mm in diameter, sample temperature 25° C., rupture test, stop at load, 0.5 mm/sec test speed, 1 N trigger load and probe TA4/1000. Certain exemplary embodiments are to a non-dairy semi-soft cheese analog comprising: a gelling component wherein the non-dairy cheese analog has a cohesiveness of approximately 0.8 or at least 0.5, 0.6, 0.65, 0.75, 0.8 without substantial rupture when tested using the following test parameters: CT3 Texture Analyzer; cylinder same sample 10 mm in length and 12 mm in diameter, sample temperature 25° C., rupture test, stop at load, 0.5 mm/sec test speed, 1 N trigger load and probe TA4/1000. In certain exemplary embodiments, the non-dairy semi-soft cheese analog may be a substantially non-dairy semi-soft cheese analog.

Certain exemplary embodiments are to a non-dairy cheese analog comprising: a gelling component wherein the non-dairy cheese analog has an average hardness of between 5 Newton and 45 Newton, between 10 Newton to 45 Newton, between 20 Newton to 45 Newton, between 25 Newton to 45 Newton, or between 35 Newton to 45 Newton. Certain exemplary embodiments are to a non-dairy cheese analog comprising: a gelling component wherein the non-dairy cheese analog has an average hardness of approximately 45 Newton or at least 10 Newton, 20 Newton, 25 Newton, 35 Newton, 45 Newton. Certain exemplary embodiments are to a non-dairy cheese analog comprising: a gelling component wherein the non-dairy cheese analog has an average hardness of between 5 Newton and 45 Newton, between 10 Newton to 45 Newton, between 20 Newton to 45 Newton, between 25 Newton to 45 Newton, or between 35 Newton to 45 Newton without rupture or substantial rupture. Certain exemplary embodiments are to a non-dairy cheese analog comprising: a gelling component wherein the non-dairy cheese analog has an average hardness of approximately 45 Newton or at least 10 Newton, 20 Newton, 25 Newton, 35 Newton, 45 Newton without rupture or substantial rupture. Certain exemplary embodiments are to a non-dairy cheese analog comprising: a gelling component wherein the non-dairy cheese analog has an average hardness of between 5 Newton and 45 Newton, between 10 Newton to 45 Newton, between 20 Newton to 45 Newton, between 25 Newton to 45 Newton, or between 35 Newton to 45 Newton without substantial rupture when tested using the following test parameters: CT3 Texture Analyzer; cylinder same sample 10 mm in length and 12 mm in diameter, sample temperature 25° C., rupture test, stop at load, 0.5 mm/sec test speed, 1 N trigger load and probe TA4/1000. In certain exemplary embodiments, the non-dairy cheese analog may be a substantially non-dairy cheese analog. Certain exemplary embodiments are to a non-dairy cheese analog comprising: a gelling component wherein the non-dairy cheese analog has an average hardness of approximately 45 Newton or at least 10 Newton, 20 Newton, 25 Newton, 35 Newton, 45 Newton without substantial rupture when tested using the following test parameters: CT3 Texture Analyzer; cylinder same sample 10 mm in length and 12 mm in diameter, sample temperature 25° C., rupture test, stop at load, 0.5 mm/sec test speed, 1 N trigger load and probe TA4/1000. In certain exemplary embodiments, the non-dairy cheese analog may be a substantially non-dairy cheese analog.

Certain exemplary embodiments are to a non-dairy semi-soft cheese analog comprising: a gelling component wherein the non-dairy cheese analog an average hardness of between 5 Newton and 45 Newton, between 10 Newton to 45 Newton, between 20 Newton to 45 Newton, between 25 Newton to 45 Newton, or between 35 Newton to 45 Newton. Certain exemplary embodiments are to a non-dairy semi-soft cheese analog comprising: a gelling component wherein the non-dairy cheese analog has an average hardness of approximately 45 Newton or at least 10 Newton, 20 Newton, 25 Newton, 35 Newton, 45 Newton. Certain exemplary embodiments are to a non-dairy semi-soft cheese analog comprising: a gelling component wherein the non-dairy cheese analog has an average hardness of between 5 Newton and 45 Newton, between 10 Newton to 45 Newton, between 20 Newton to 45 Newton, between 25 Newton to 45 Newton, or between 35 Newton to 45 Newton without rupture or substantial rupture. Certain exemplary embodiments are to a non-dairy semi-soft cheese analog comprising: a gelling component wherein the non-dairy cheese analog has an average hardness of approximately 45 Newton or at least 10 Newton, 20 Newton, 25 Newton, 35 Newton, 45 Newton without rupture or substantial rupture. Certain exemplary embodiments are to a non-dairy semi-soft cheese analog comprising: a gelling component wherein the non-dairy cheese analog has an average hardness of between 5 Newton and 45 Newton, between 10 Newton to 45 Newton, between 20 Newton to 45 Newton, between 25 Newton to 45 Newton, or between 35 Newton to 45 Newton without substantial rupture when tested using the following test parameters: CT3 Texture Analyzer; cylinder same sample 10 mm in length and 12 mm in diameter, sample temperature 25° C., rupture test, stop at load, 0.5 mm/sec test speed, 1 N trigger load and probe TA4/1000. Certain exemplary embodiments are to a non-dairy semi-soft cheese analog comprising: a gelling component wherein the non-dairy cheese analog has an average hardness of approximately 45 Newton or at least 10 Newton, 20 Newton, 25 Newton, 35 Newton, 45 Newton without substantial rupture when tested using the following test parameters: CT3 Texture Analyzer; cylinder same sample 10 mm in length and 12 mm in diameter, sample temperature 25° C., rupture test, stop at load, 0.5 mm/sec test speed, 1 N trigger load and probe TA4/1000. In certain exemplary embodiments, the non-dairy semi-soft cheese analog may be a substantially non-dairy semi-soft cheese analog.

The present disclosure will now be described with reference to specific example(s), which should not be construed as in any way limiting.

### Example 1: A High Protein Non-Dairy Cheese Analog

Table 1 below provides an exemplary formulation that was used to produce a non-dairy cheese analog.

TABLE 1

| Ingredient | Percent by weight |
|---|---|
| Water | 58 |
| Pea Protein (Puris 870, World Foods) | 13 |
| Coconut Oil | 12 |
| Potato Starch (Penbind 851, Ingredion) | 12 |
| Sugar | 2 |
| High Acyl Gellan Gum (Ticagel Gellan HS, | 1 |
| TIC gums) | |
| Sunflower Oil | 2 |

The non-dairy cheese analog of Table 1 was prepared by blending water, pea protein, coconut oil, potato starch, and sunflower oil in a Thermomix (Vorwerk USA) at a speed of 6 and temperature of 75° C. for 5 minutes. High acyl gellan gum and sugar were added and mixed at a speed of 4 and a temperature of 90° C. for 10 minutes. This mixture was allowed to set at 4° C. for two days.

Texture analysis was performed on the exemplary non-dairy cheese analog and compared to commercial non-dairy cheese (Daiya Medium Cheddar Style) and traditional dairy cheese (Berkeley Bowl Low Moisture Mozzarella). Samples were cut into 12 mm (d)×10 mm (h) cylinders and a rupture test was performed with the CT3 Texture Analyzer (Brookfield Engineering) with the parameters in Table 2. From six samples taken the average hardness, with standard deviation, and average strain at peak hardness, with standard deviation, was found. These values were 42.97 N+/−1.46 N and 0.56+/−0.02 respectively.

Texture analysis was also performed on the described non-dairy cheese analog via a TPA test to determine the corresponding cohesiveness. Samples were cut into 12 mm (d)×10 mm (h) cylinders and a TPA test was performed with the CT3 Texture Analyzer (Brookfield Engineering) with the parameters in Table 3. From six samples taken average cohesiveness with standard deviation was found. This value was 0.77+/−0.02.

TABLE 2
Parameters for texture analysis rupture test.

| Parameter | Value | Units |
|---|---|---|
| Sample Shape | Cylinder | |
| Sample Length | 10 | Mm |
| Sample Diameter | 12 | Mm |
| Sample Temperature | 25 | Celsius |
| Test Type | Rupture | |
| Target Type | Stop @ Load | |
| Target Values | 44.1 | N |
| Hold Time | 0 | Seconds |
| Trigger Load | 1 | N |
| Test Speed | 0.5 | mm/s |
| Return at | Test Speed | |
| Post Test Speed | 4.5 | mm/s |
| Probe | TA4/1000 | |
| Cycle Count | 1 | |
| Recovery time | 0 | Sec |

TABLE 3
Parameters for Texture Analysis TPA Test

| Parameter | Value | Units |
|---|---|---|
| Sample Shape | Cylinder | |
| Sample Length | 10 | Mm |
| Sample Diameter | 12 | Mm |
| Test Type | TPA | |
| Target Type | % Deformation | |
| Target Value | 25 | % |
| Hold Time | 0 | Seconds |
| Trigger Load | 1 | N |
| Test Speed | 0.5 | mm/s |
| Return at | Test Speed | |
| Post Test Speed | 4.5 | mm/s |
| Probe | TA4/1000 | |
| Cycle Count | 2 | |
| Recovery time | 0 | Seconds |
| Sample Temperature | 25 | Celsius |

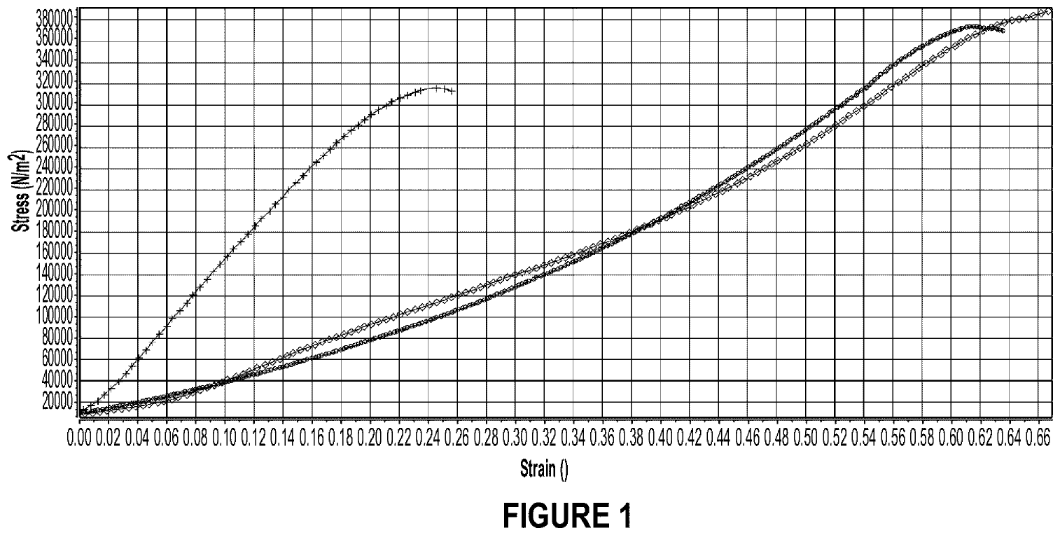

Low-moisture dairy mozzarella does not rupture under the test conditions and is able to be compressed to a strain of 0.66, or a compressibility of 66% (FIG. 1, diamond symbols). This compressibility is characteristic of semi-soft dairy cheeses. Daiya commercial non-dairy cheese ruptured at a strain of 0.24, or a compressibility of 24% (FIG. 1, plus symbols). These results are characteristic of a brittle cheese with limited compressibility. The non-dairy cheese analog described above ruptured at 0.6, or a compressibility of 60% (FIG. 1, circle symbols). The described non-dairy cheese analog shows high compressibility, giving it a texture reminiscent of a semi-soft dairy cheese (e.g., mozzarella). The non-dairy cheese analog prepared was substantially less brittle than the Daiya commercial non-dairy cheese.

### Example 2: A Starch-Based Non-Dairy Cheese Analog

A non-dairy cheese analog containing Palm Oil (15%), Potato Starch (Penbind 851, Ingredion, 20%), Sugar (2%), high acyl gellan gum (Ticagel Gellan HS, TIC gums, 1.5%), and Water (61.5%) is produced following the method described in Example 1. The non-dairy cheese analog will have a suitable compressibility for a non-dairy semi-soft cheese analog.

### Example 3: Exemplary Non-Dairy Cheese Analog

A non-dairy cheese analog (Table 4) was made by blending water, pea protein, coconut oil, potato starch, and sunflower oil in a Thermomix (Vorwerk USA) at a speed of 6 and temperature of approximately 75° C. for approximately 5 minutes. High Acyl gellan gum and sugar was added and mixed at a speed of 4 and a temperature of approximately 90° C. for approximately 10 minutes. This mixture was allowed to set at 4° C. for approximately two days.

TABLE 4

| Ingredient | Weight Percent |
|---|---|
| Water | 53 |
| Refined Pea Protein (see, e.g., example 10) | 30 |
| Coconut Oil | 12 |
| Sunflower Oil | 2 |
| Potato Starch (Precisa 604 Modified Potato | Zero |
| Starch, Ingredion) | |
| Sugar | 2 |
| High Acyl Gellan Gum (Ticagel Gellan HS, | 1 |
| TIC Gums) | |

Texture analysis was performed on the described non-dairy cheese analog and compared to commercial non-dairy cheese (Daiya Medium Cheddar Style Block) and traditional dairy cheese (Berkeley Bowl Mozzarella block). Samples were cut into 12 mm (d)×10 mm (h) cylinders and a rupture test was performed with the CT3 Texture Analyzer (Brookfield Engineering) with the parameters in Table 2. From six samples taken the average hardness, with standard deviation, and average strain at peak hardness, with standard deviation, was found. These values were 18.36 N+/−1.36 N and 0.34+/−0.03 respectively.

Texture analysis was also performed on the described non-dairy cheese analog via a TPA test to determine the corresponding cohesiveness. Samples were cut into 12 mm (d)×10 mm (h) cylinders and a TPA test was performed with the CT3 Texture Analyzer (Brookfield Engineering) with the parameters in Table 3. From six samples taken average cohesiveness with standard deviation was found. This value was 0.57+/−0.02.

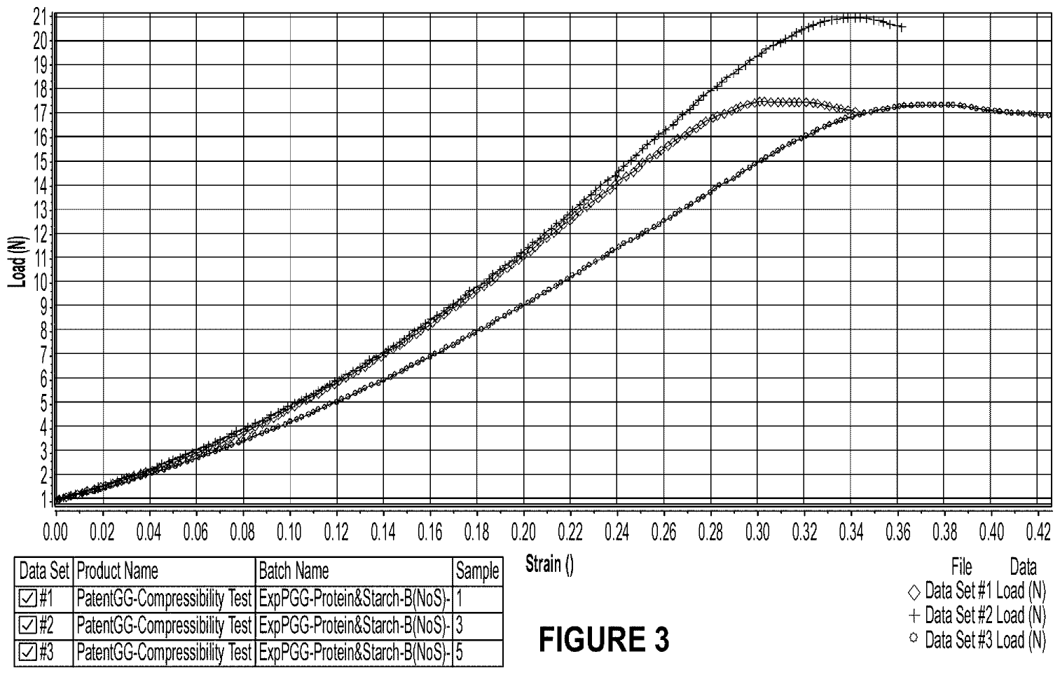

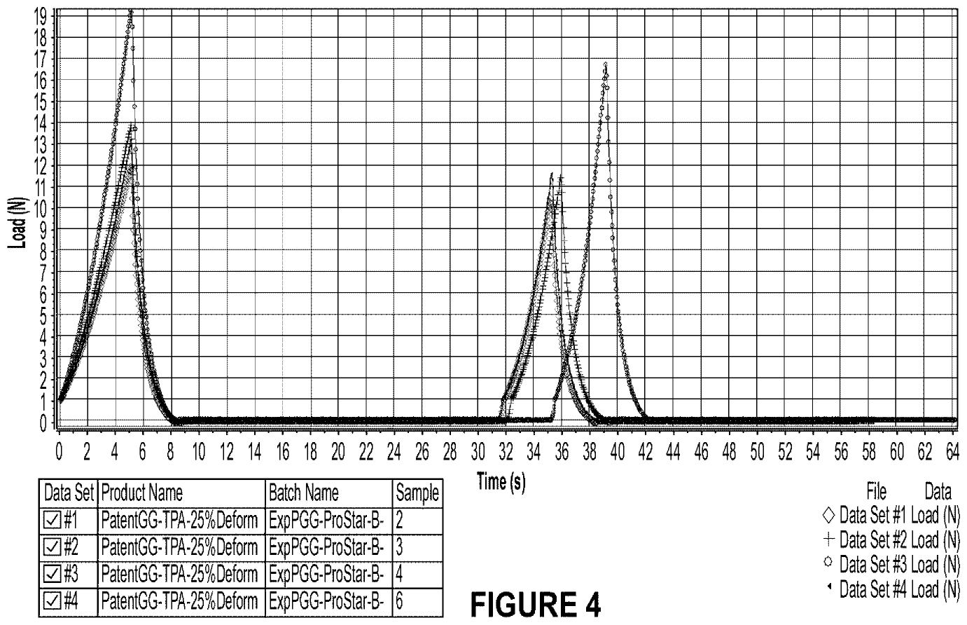

FIG. 3 shows the rupture texture analysis output of an exemplary protein cheese analogy. FIG. 4 shows the range of hardness and strain seen via the rupture test. The line with the plus signs represents the max hardness seen in the tests. The line with the circles represents the lowest hardness and highest strain seen in our rupture test. The line with the diamonds represents the lowest strain that was seen in our rupture test.

FIG. 4 shows the shows the TPA test texture analysis profile of exemplary protein cheese analog and shows the range of cycle one hardness and cohesiveness seen via the TPA tests performed. The line with the circles represents the max cycle one hardness seen. The line with the diamonds represents the minimum cycle one hardness seen. The line with the filled triangles represent the sample with the max cohesiveness. The line with the plus symbols represent the minimum cohesiveness sample.

### Example 4: Exemplary Modified Starch Non-Dairy Cheese Analog

A non-dairy cheese analog (Table 5) was made by blending water, pea protein, coconut oil, potato starch, and sunflower oil in a Thermomix (Vorwerk USA) at a speed of 6 and temperature of 75° C. for 5 minutes. High Acyl gellan gum and sugar was added and mixed at a speed of 4 and a temperature of 90° C. for 10 minutes. This mixture was allowed to set at 4° C. for two days.

TABLE 5

| Ingredient | Weight Percent |
|---|---|
| Water | 52.5 |
| Refined Pea Protein (see, e.g., example 10) | 0 |
| Coconut Oil | 12 |
| Sunflower Oil | 2 |
| Potato Starch (Precisa 604 Modified Potato | 30 |
| Starch, Ingredion) | |
| Sugar | 2 |
| High Acyl Gellan Gum (Ticagel Gellan HS, | 1.5 |
| TIC Gums) | |

Texture analysis was performed on the described non-dairy cheese analog and compared to commercial non-dairy cheese (Daiya Medium Cheddar Style Block) and traditional dairy cheese (Berkeley Bowl Mozzarella block). Samples were cut into 12 mm (d)×10 mm (h) cylinders and a rupture test was performed with the CT3 Texture Analyzer (Brookfield Engineering) with the parameters in Table 2. From six samples taken the average hardness, with standard deviation, and average strain at peak hardness, with standard deviation, was found. These values were 44.00 N+/−0.17 N and 0.31+/−0.02 respectively.

Texture analysis was also performed on the described non-dairy cheese analog via a TPA test to determine the corresponding cohesiveness. Samples were cut into 12 mm (d)×10 mm (h) cylinders and a TPA test was performed with the CT3 Texture Analyzer (Brookfield Engineering) with the parameters in Table 3. From six samples taken average cohesiveness with standard deviation was found, this value was 0.76+/−0.03.

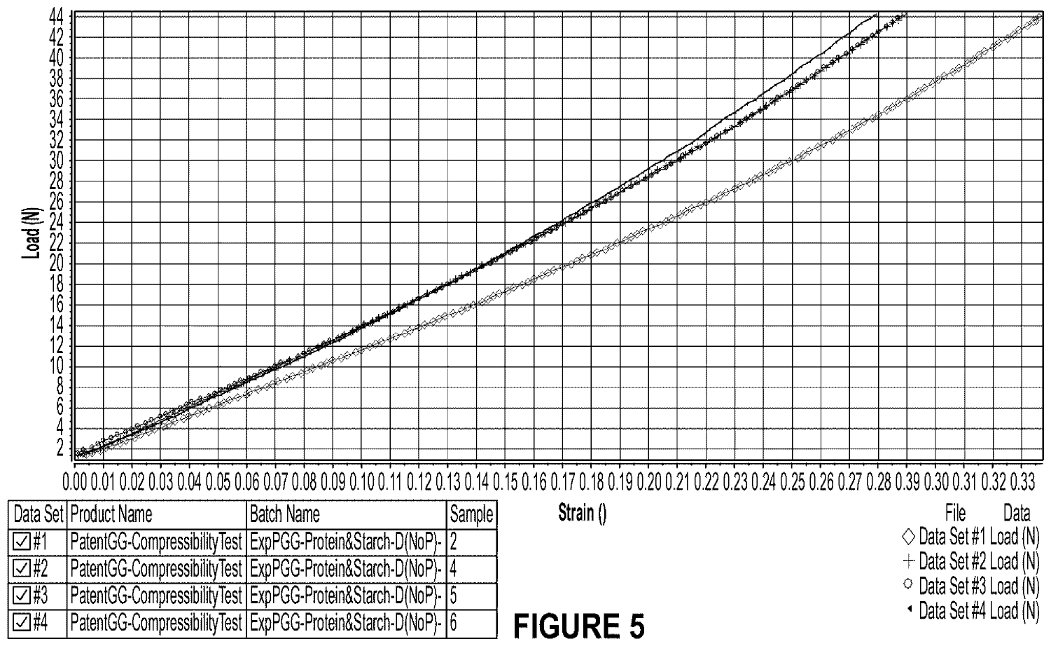

FIG. 5 shows the rupture test texture analysis profile of exemplary modified starch cheese analog. FIG. 5 shows the range of hardness and strain seen via the rupture test. The line with the circles represents the max hardness seen in the rupture test. The line with the plus signs represent the minimum hardness seen in the rupture test. The line with the diamonds represents the max strain seen in the rupture test. The line with the filled in triangles represent the minimum strain seen in the rupture test.

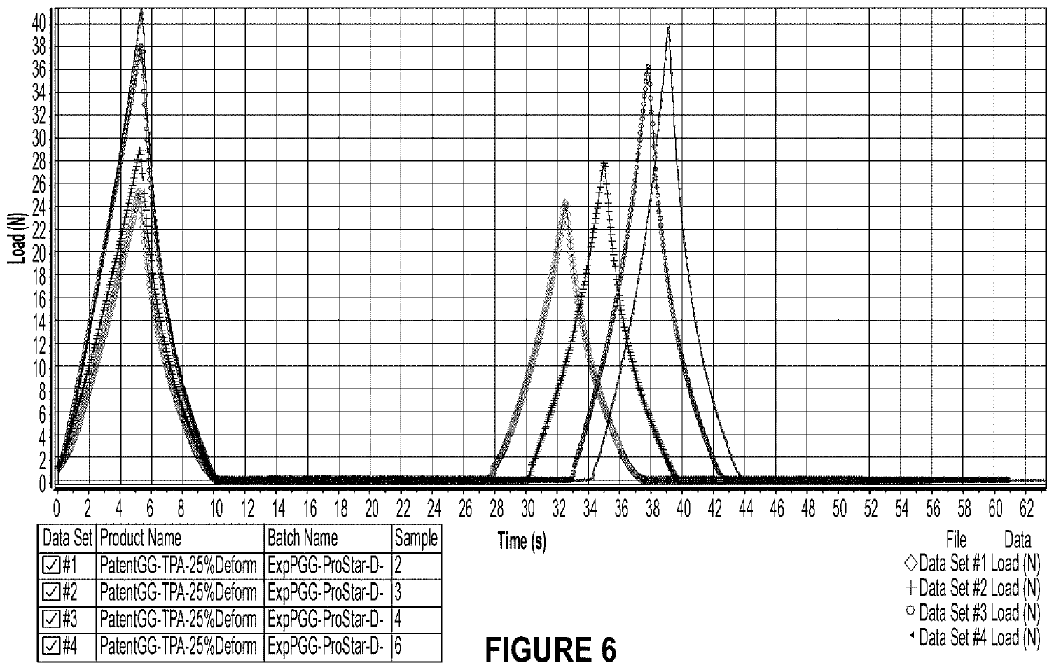

FIG. 6 shows the TPA test texture analysis profile of exemplary modified starch cheese analog. FIG. 6 shows the TPA test for the modified starch cheese. The line with the filled in triangles represent the max cycle one hardness seen in the TPA test. The line with the diamonds represents the minimum cycle one hardness seen in the TPA test. The line with the pluses represents the max cohesiveness and the line with the circles represents the minimum cohesiveness seen.

### Example 5: Exemplary Native Starch Non-Dairy Cheese Analog

The ingredients of this exemplary native starch cheese analog are provided in Table 6. The non-dairy cheese analog was made by blending water, pea protein, coconut oil, potato starch, and sunflower oil in a Thermomix (Vorwerk USA) at a speed of 6 and temperature of 75° C. for 5 minutes. High Acyl gellan gum and sugar was added and mixed at a speed of 4 and a temperature of 90° C. for 10 minutes. This mixture was allowed to set at 4° C. for two days.

TABLE 6

| Ingredient | Weight Percent |
|---|---|
| Water | 59.5 |
| Refined Pea Protein (see, e.g., example 10) | 0 |
| Coconut Oil | 6 |
| Sunflower Oil | 1 |
| Potato Starch (Native Tapioca Starch, | 30 |
| Ingredion) | |
| Sugar | 2 |
| High Acyl Gellan Gum (Ticagel Gellan HS, | 1.5 |
| TIC Gums) | |

Texture analysis was performed on the described non-dairy cheese analog and compared to commercial non-dairy cheese (Daiya Medium Cheddar Style Block) and traditional dairy cheese (Berkeley Bowl Mozzarella block). Samples were cut into 12 mm (d)×10 mm (h) cylinders and a rupture test was performed with the CT3 Texture Analyzer (Brookfield Engineering) with the parameters in Table 2. From six samples taken the average hardness, with standard deviation, and average strain at peak hardness, with standard deviation, was found. These values were 43.79 N+/−0.19 N and 0.55+/−0.04 respectively.

Texture analysis was also performed on the described non-dairy cheese analog via a TPA test to determine the corresponding cohesiveness. Samples were cut into 12 mm (d)×10 mm (h) cylinders and a TPA test was performed with the CT3 Texture Analyzer (Brookfield Engineering) with the parameters in Table 3. From six samples taken average cohesiveness with standard deviation was found. This value was 0.92+/−0.06.

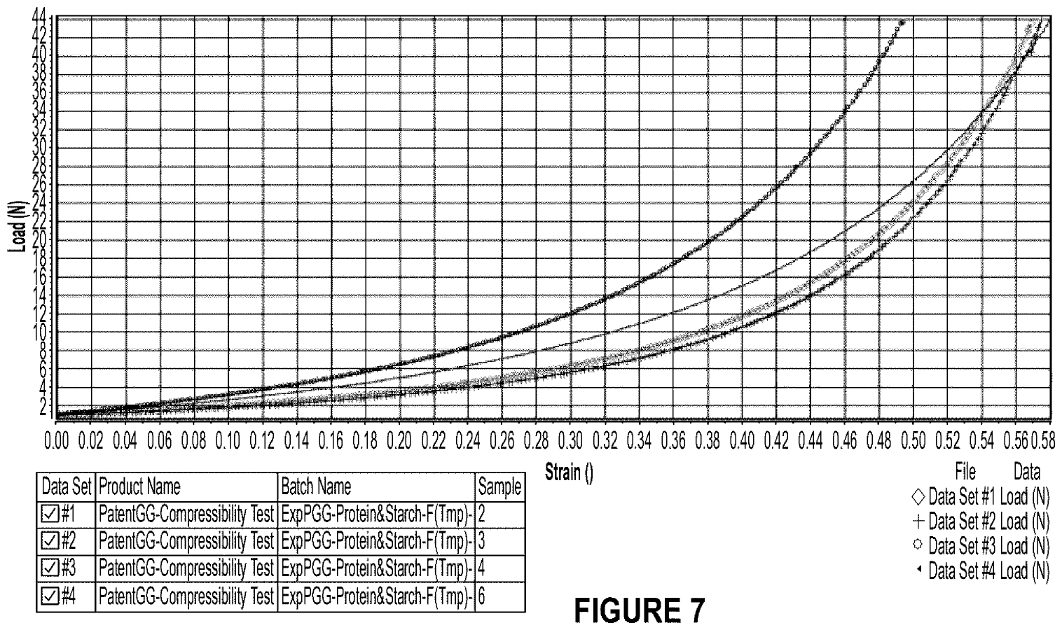

FIG. 7 shows the rupture test texture analysis profile of an exemplary native starch cheese analog. FIG. 7 shows the range of hardness and strain seen via the rupture test. The line with the pluses represents the max hardness seen in the rupture test. The line with the diamond represents the minimum hardness seen in the rupture test. The line with the filled in triangles represents the max strain seen in the rupture test. The line with the circles represent the minimum strain seen in the rupture test.

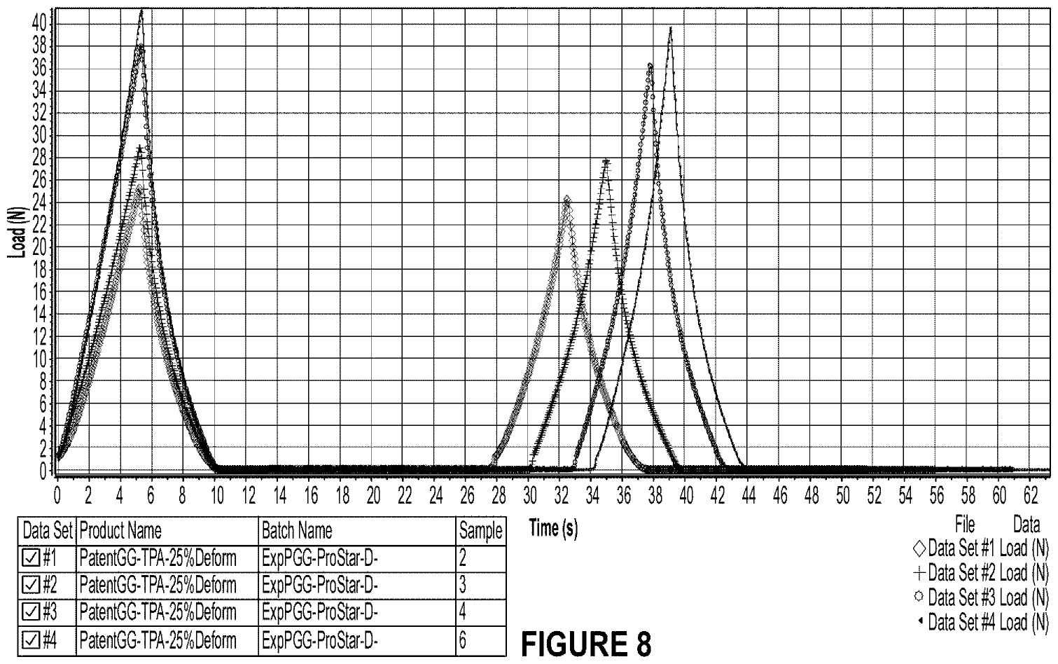

FIG. 8 shows the TPA test for an exemplary native starch cheese. The line with the circles represent the max cycle one hardness seen and the minimum cohesiveness seen in the TPA test. The line with the plus signs represent the minimum cycle one hardness seen in the TPA test. The line with the diamonds represents the max cohesiveness seen in the TPA test.

### Example 6: Exemplary High Acyl Gellan Gum Non-Dairy Cheese Analog

A non-dairy cheese analog (Table 7) was made by blending water, pea protein, coconut oil, potato starch, and sunflower oil in a Thermomix (Vorwerk USA) at a speed of 6 and temperature of approximately 75° C. for approximately 5 minutes. High Acyl gellan gum and sugar was added and mixed at a speed of 4 and a temperature of approximately 90° C. for approximately 10 minutes. This mixture was allowed to set at approximately 4° C. for two days.

TABLE 7

| Ingredient | Weight Percent |
|---|---|
| Water | 54 |
| Refined Pea Protein (see, e.g., example 10) | 13 |
| Coconut Oil | 12 |
| Sunflower Oil | 2 |
| Potato Starch (Precisa 604 Modified Potato | 12 |
| Starch, Ingredion) | |
| Sugar | 2 |
| High Acyl Gellan Gum (Ticagel Gellan HS, | 5 |
| TIC Gums) | |

Texture analysis was performed on the described non-dairy cheese analog and compared to commercial non-dairy cheese (Daiya Medium Cheddar Style Block) and traditional dairy cheese (Berkeley Bowl Mozzarella block). Samples were cut into 12 mm (d)×10 mm (h) cylinders and a rupture test was performed with the CT3 Texture Analyzer (Brookfield Engineering) with the parameters in Table 2. From six samples taken the average hardness, with standard deviation, and average strain at peak hardness, with standard deviation, was found. These values were 43.98 N+/−0.19 N and 0.41+/−0.02 respectively.

Texture analysis was also performed on the described non-dairy cheese analog via a TPA test to determine the corresponding cohesiveness. Samples were cut into 12 mm (d)×10 mm (h) cylinders and a TPA test was performed with the CT3 Texture Analyzer (Brookfield Engineering) with the parameters in Table 3. From six samples taken average cohesiveness with standard deviation was found. This value was 0.83+/−0.01.

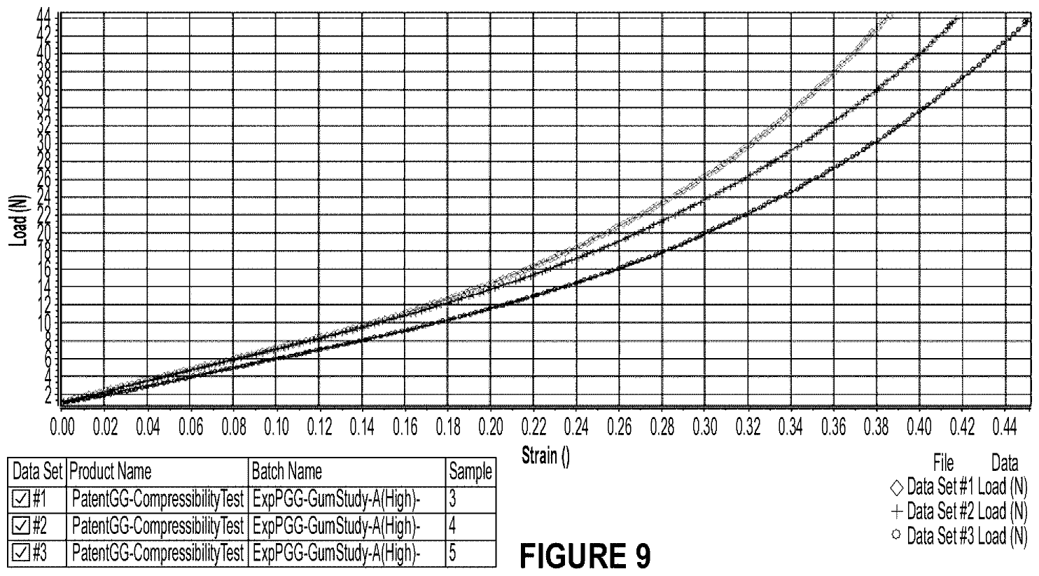

FIG. 9 shows the rupture test texture analysis profile of the exemplary high gellan gum cheese analog. FIG. 9 shows the range of hardness and strain seen via the rupture test. The line with the diamonds represents the max hardness seen and the lowest strain seen in the rupture test. The line with the circles represent the minimum hardness seen in the rupture test. The line with the filled in triangles represents the max strain seen in the rupture test.

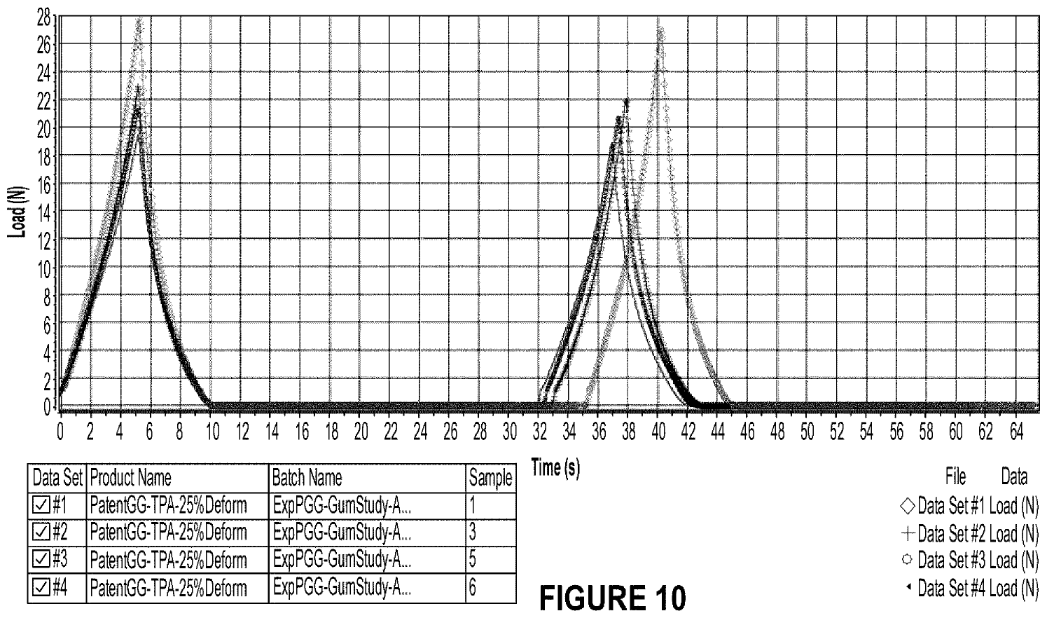

FIG. 10 shows the TPA test texture analysis profile of the exemplary high gellan gum cheese analog. FIG. 10 shows the TPA test for the high gellan gum cheese analog. The line with the diamonds represent the max cycle one hardness seen in the TPA test. The line with the filled in triangles represent the minimum cycle one hardness seen in the TPA test. The line with the circles represents the max cohesiveness seen in the TPA test. The line with the plus signs represents the minimum cohesiveness seen in the TPA test.

### Example 7: Exemplary High Acyl Gellan Gum Non-Dairy Cheese Analog

A non-dairy cheese analog (Table 8) was made by blending water, pea protein, coconut oil, potato starch, and sunflower oil in a Thermomix (Vorwerk USA) at a speed of 6 and temperature of approximately 75° C. for approximately 5 minutes. High Acyl gellan gum and sugar was added and mixed at a speed of 4 and a temperature of approximately 90° C. for approximately 10 minutes. This mixture was allowed to set at approximately 4° C. for two days.

TABLE 8

| Ingredient | Weight Percent |
|---|---|
| Water | 58.65 |
| Refined Pea Protein (see, e.g., example 10) | 13 |
| Coconut Oil | 12 |
| Sunflower Oil | 2 |
| Potato Starch (Precisa 604 Modified Potato | 12 |
| Starch, Ingredion) | |
| Sugar | 2.0 |
| High Acyl Gellan Gum (Ticagel Gellan HS, | 0.35 |
| TIC Gums) | |

Texture analysis was performed on the described non-dairy cheese analog and compared to commercial non-dairy cheese (Daiya Medium Cheddar Style Block) and traditional dairy cheese (Berkeley Bowl Mozzarella block). Samples were cut into 12 mm (d)×10 mm (h) cylinders and a rupture test was performed with the CT3 Texture Analyzer (Brookfield Engineering) with the parameters in Table 2. From six samples taken the average hardness, with standard deviation, and average strain at peak hardness, with standard deviation, was found. These values were 6.21 N+/−0.82 N and 0.31+/−0.01 respectively.

Texture analysis was also performed on the described non-dairy cheese analog via a TPA test to determine the corresponding cohesiveness. Samples were cut into 12 mm (d)×10 mm (h) cylinders and a TPA test was performed with the CT3 Texture Analyzer (Brookfield Engineering) with the parameters in Table 3. From six samples taken average cohesiveness with standard deviation was found. This value was 0.58+/−0.02.

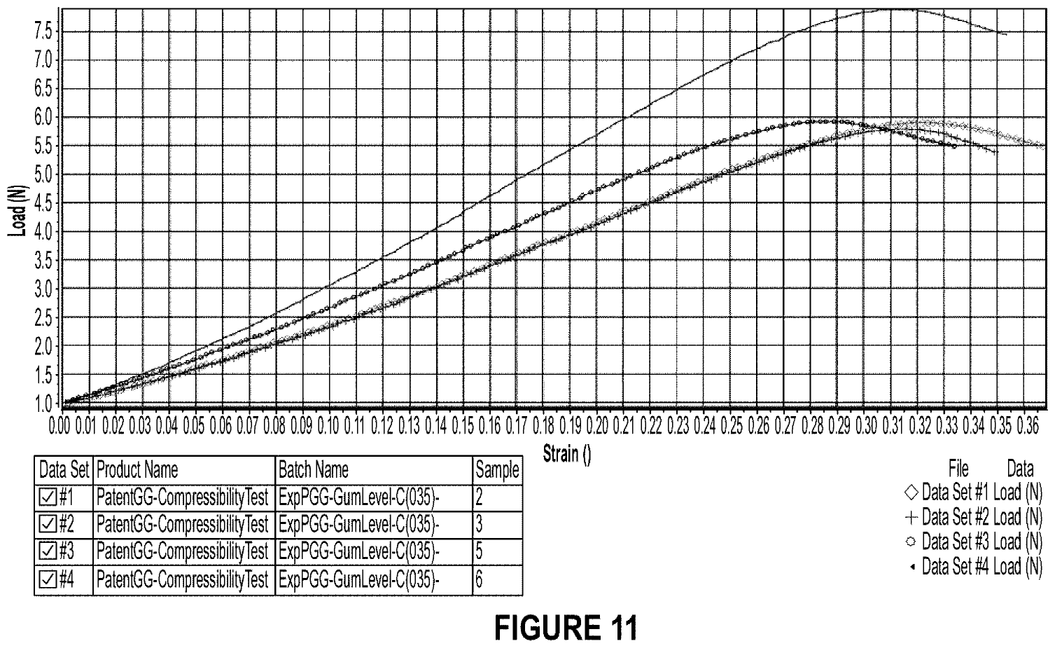

FIG. 11 shows the rupture test texture analysis profile of the exemplary low percent gellan gum cheese analog. FIG. 11 shows the range of hardness and strain seen via the rupture test. The line with the filled in triangles represents the max hardness seen in the rupture test. The line with the plus signs represent the minimum hardness seen in the rupture test. The line with the diamonds represents the max strain seen in the rupture test. The line with the circles represent the minimum strain seen in the rupture test.

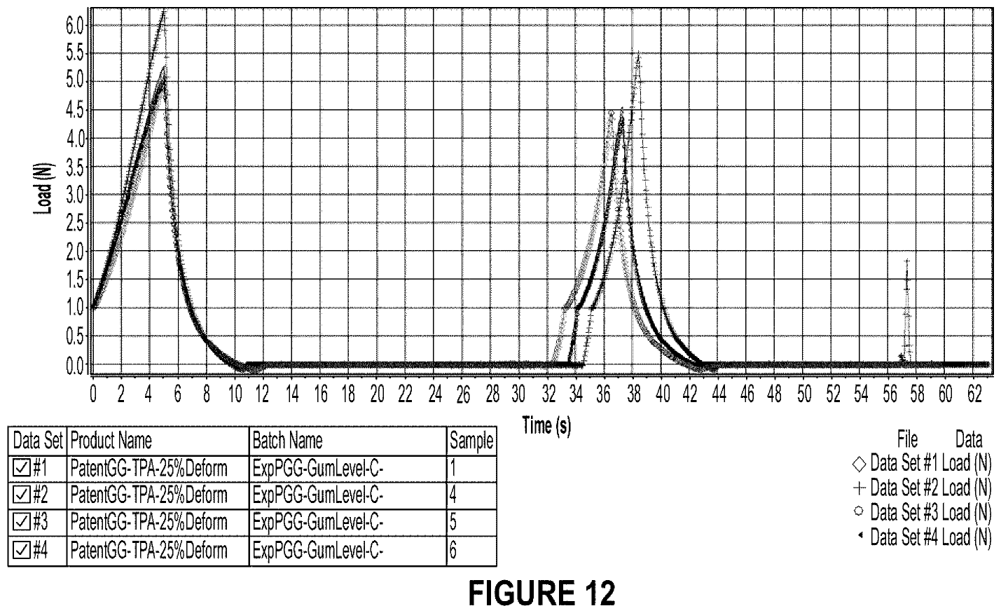

FIG. 12 shows the TPA test for the exemplary low percent gellan gum cheese analog. The line with the plus signs represent the max cycle one hardness seen in the TPA test. The line with the circles represent the minimum cycle one hardness seen in the TPA test. The line with the diamonds represents the max cohesiveness seen in the TPA test. The line with the filled in triangles represents the minimum cohesiveness seen in the TPA test.

### Example 8: Exemplary Non-Dairy Cheese Analog

A non-dairy cheese analog (Table 9) was made by blending water, pea protein, coconut oil, potato starch, and sunflower oil in a Thermomix (Vorwerk USA) at a speed of 6 and temperature of approximately 75° C. for approximately 5 minutes. High Acyl gellan gum and sugar was added and mixed at a speed of 4 and a temperature of approximately 90° C. for approximately 10 minutes. This mixture was allowed to set at approximately 4° C. for two days.

TABLE 9

| Ingredient | Weight Percent |
|---|---|
| Water | 42 |
| Refined Pea Protein (see, e.g., example 10) | 13 |
| Coconut Oil | 20 |
| Sunflower Oil | 10 |
| Potato Starch (Precisa 604 Modified | 12 |
| Potato Starch, Ingredion) | |
| Sugar | 2 |
| High Acyl Gellan Gum (Ticagel Gellan | 1 |
| HS, TIC Gums) | |

Texture analysis was performed on the described non-dairy cheese analog and compared to commercial non-dairy cheese (Daiya Medium Cheddar Style Block) and traditional dairy cheese (Berkeley Bowl Mozzarella block). Samples were cut into 12 mm (d)×10 mm (h) cylinders and a rupture test was performed with the CT3 Texture Analyzer (Brookfield Engineering) with the parameters in Table 2. From six samples taken the average hardness, with standard deviation, and average strain at peak hardness, with standard deviation, was found. These values were 21.54 N+/−4.68 N and 0.35+/−0.04 respectively.

Texture analysis was also performed on the described non-dairy cheese analog via a TPA test to determine the corresponding cohesiveness. Samples were cut into 12 mm (d)×10 mm (h) cylinders and a TPA test was performed with the CT3 Texture Analyzer (Brookfield Engineering) with the parameters in Table 3. From six samples taken average cohesiveness with standard deviation was found. This value was 0.64+/−0.09.

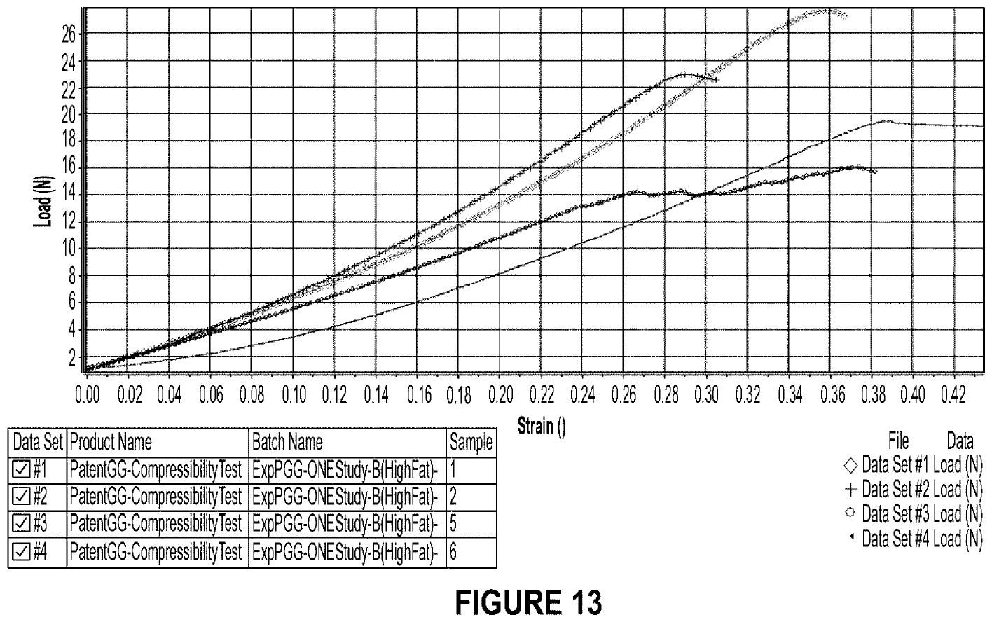

FIG. 13 shows the rupture test texture analysis profile of an exemplary high fat cheese analog. FIG. 13 shows the range of hardness and strain seen via the rupture test. The line with the diamonds represents the max hardness seen in the rupture test. The line with the circles represent the minimum hardness seen in the rupture test. The line with the filled in triangles represents the max strain seen in the rupture test. The line with the plus signs represent the minimum strain seen in the rupture test.

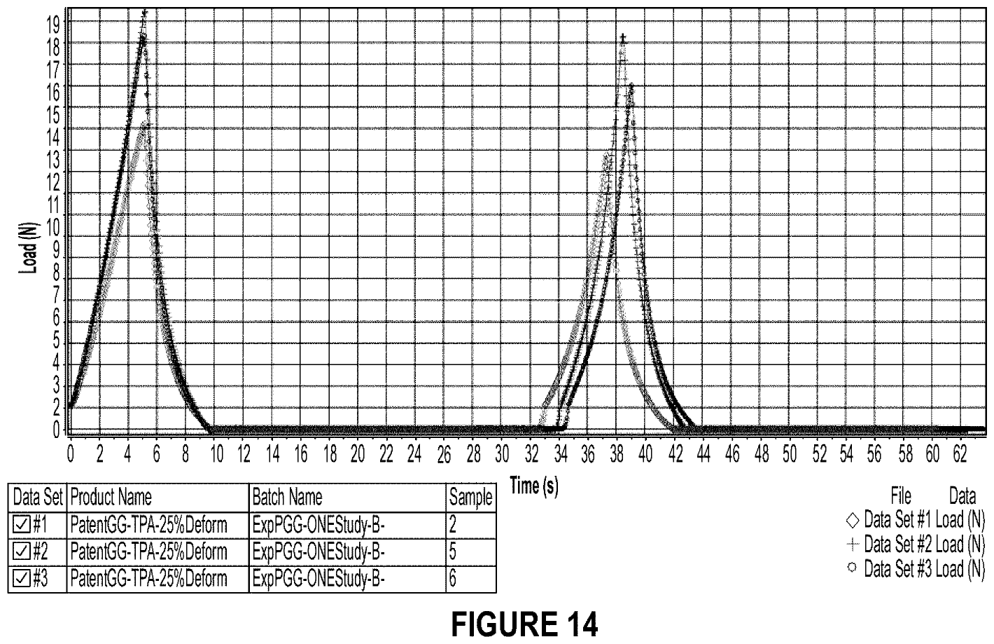

FIG. 14 shows the TPA test for the exemplary high fat cheese analog. The line with the plus signs represent the max cycle one hardness seen and the max cohesiveness seen in the TPA test. The line with the diamonds represent the minimum cycle one hardness seen in the TPA test. The line with the circles represents the minimum cohesiveness seen in the TPA test.

### Example 9: Exemplary Non-Dairy Cheese Analog

A non-dairy cheese analog (Table 10) was made by blending water, pea protein, coconut oil, potato starch, and sunflower oil in a Thermomix (Vorwerk USA) at a speed of 6 and temperature of approximately 75° C. for approximately 5 minutes. High Acyl gellan gum and sugar was added and mixed at a speed of 4 and a temperature of approximately 90° C. for approximately 10 minutes. This mixture was allowed to set at approximately 4° C. for two days.

TABLE 10

| Ingredient | Weight Percent |
|---|---|
| Water | 72 |
| Refined Pea Protein (see, e.g., example 10) | 13 |
| Coconut Oil | 0 |
| Sunflower Oil | 0 |
| Potato Starch (Precisa 604 Modified Potato | 12 |
| Starch, Ingredion) | |
| Sugar | 2 |
| High Acyl Gellan Gum (Ticagel Gellan | 1 |
| HS, TIC Gums) | |

Texture analysis was performed on the described non-dairy cheese analog and compared to commercial non-dairy cheese (Daiya Medium Cheddar Style Block) and traditional dairy cheese (Berkeley Bowl Mozzarella block). Samples were cut into 12 mm (d)×10 mm (h) cylinders and a rupture test was performed with the CT3 Texture Analyzer (Brookfield Engineering) with the parameters in Table 2. From six samples taken the average hardness, with standard deviation, and average strain at peak hardness, with standard deviation, was found. These values were 42.61 N+/−1.54 N and 0.53+/−0.06 respectively.

Texture analysis was also performed on the described non-dairy cheese analog via a TPA test to determine the corresponding cohesiveness. Samples were cut into 12 mm (d)×10 mm (h) cylinders and a TPA test was performed with the CT3 Texture Analyzer (Brookfield Engineering) with the parameters in Table 3. From six samples taken average cohesiveness with standard deviation was found. This value was 0.76+/−0.01.

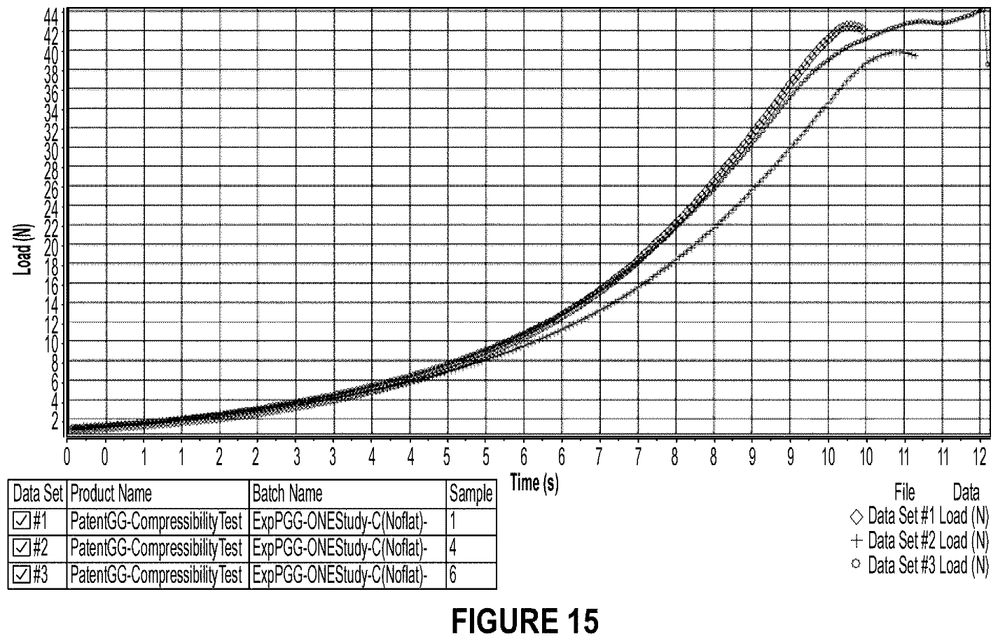

FIG. 15 shows the rupture test texture analysis profile of the exemplary no fat cheese analog. FIG. 15 shows the range of hardness and strain seen via the rupture test. The line with the circles represents the max hardness seen and the max strain seen in the rupture test. The line with the plus signs represent the minimum hardness seen in the rupture test. The line with the diamonds represents the minimum strain seen in the rupture test.

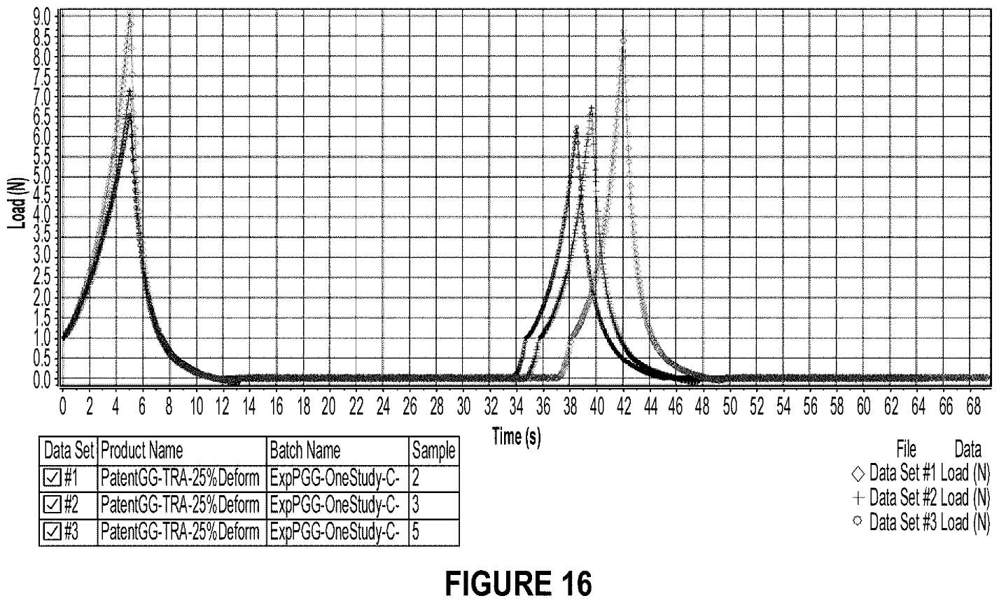

FIG. 16 shows the TPA test for the exemplary no fat cheese analog. The line with the diamonds represent the max cycle one hardness seen in the TPA test. The line with the circles represent the minimum cycle one hardness seen and the minimum cohesiveness seen in the TPA test. The line with the plus signs represents the max cohesiveness seen in the TPA test.

Table 11 (below) provides a summary of the texture analysis of the exemplary embodiments illustrated in examples 1 to 9 and compares that data with the texture analysis with commercial non-dairy cheese (Daiya Medium Cheddar Style Block) and traditional dairy cheese (Berkeley Bowl Mozzarella block).

TABLE 11

| | | | | Peak | | |
|---|---|---|---|---|---|---|
| | | Compressibility | Average | Hardness | | |
| | Average | Standard | Peak | Standard | | Cohesiveness |
| Sample | Compressibility | Deviation | Hardness | Deviation | Average | Standard |
| Name | (%) | (%) | (N) | (N) | Cohesiveness | Deviation |
| Ex 1 | 55.67 | 1.51 | 42.97 | 1.46 | 0.77 | 0.02 |
| Ex 2 | | | | | | |
| Ex 3 | 34 | 0.03 | 18.36 | 1.36 | 0.57 | 0.02 |
| Ex 4 | 30.83 | 2.48 | 44 | 0.17 | 0.76 | 0.03 |
| Ex 5 | 55.17 | 3.54 | 43.79 | 0.19 | 0.92 | 0.06 |
| Ex 6 | 40.67 | 2.42 | 43.98 | 0.19 | 0.83 | 0.01 |
| Ex 7 | 30.67 | 1.21 | 6.21 | 0.82 | 0.58 | 0.02 |
| Ex 8 | 35 | 3.52 | 21.54 | 4.68 | 0.64 | 0.09 |
| Ex 9 | 52.5 | 5.5 | 42.61 | 1.54 | 0.76 | 0.01 |
| Dairy | 66 | 4.36 | 44.32 | 0.39 | 0.74 | 0.05 |
| Mozzarella | | | | | | |
| Daiya | 21.25 | 0.5 | 20.13 | 2.21 | 0.27 | 0.07 |
| Medium | | | | | | |
| Cheddar | | | | | | |
| Style | | | | | | |
| Block | | | | | | |

### Example 10: Method for Producing a Refined Protein at Commercial Scale

The following example illustrates a method of making exemplary refined pea protein, as disclosed herein, at a commercial scale. The steps were as follows:
1. 600-kg of pea protein isolate (Roquette S85F) was batched with water for a final solids loading of 12% (by wt %).
2. 3.2-kg of NaOH was mixed into the pea protein and water slurry.
3. 46-kg of 34% (by wt) HCl was then mixed into the pea protein and water slurry.
4. 17.8-kg of anhydrous CaCl2 was then mixed into the pea protein and water slurry.
5. The mixture was recirculated through 3 parallel decanter centrifuges, removing 22 gpm of liquid from the slurry that was replaced with 22 gpm pure water for 2.5 hours until bulk conductivity was reduced to 2500 uS/cm2.6.
6. The slurry was then dewatered using the decanter centrifuges until final dry solids was between 19-25%, and the protein was loaded into 275 gallon totes.

Further advantages of the claimed subject matter will become apparent from the following examples describing certain embodiments of the claimed subject matter.

Example 1A. A non-dairy cheese analog comprising: a gelling component wherein the non-dairy cheese analog has a compressibility of between 40% and 100% without rupture or substantial rupture.

2A. The non-dairy cheese analog of example 1A, wherein the gelling component is a high acyl gellan gum.

3A. The non-dairy cheese analog of examples 1A or 2A, wherein the high acyl gellan gum is between 0.2% and 5% by weight of the non-dairy cheese analog.

4A. The non-dairy cheese analog of one or more of examples 1A to 3A, wherein the compressibility is greater than 60%, 70% or 80%.

5A. The non-dairy cheese analog of one or more of examples 1A to 4A, wherein the high acyl gellan gum is between 0.8% and 1.2% or 1.4% and 1.6% by weight of the non-dairy cheese analog.

6A. The non-dairy cheese analog of one or more of examples 1A to 5A, wherein the high acyl gellan gum on a percent weight basis of the high acyl gellan gum is at least 80, 90, 95 or 98% high acyl gellan gum.

7A. The non-dairy cheese analog of one or more of examples 1A to 6A, wherein the high acyl gellan gum is a mixture of high acyl gellan gum and low acyl gellan gum.

8A. The non-dairy cheese analog of one or more of examples 1A to 7A, wherein the non-dairy cheese analog further comprises: a) between 8% to 16% by weight of a plant protein; b) between 8% to 18% of a starch; and c) between 8 to 18% by weight of one or more plant oils.

9A. The non-dairy cheese analog of one or more of examples 1A to 7A, wherein the non-dairy cheese analog further comprises: a) between 15% to 30% of a starch; and b) between 10 to 20% by weight of one or more plant oils.

10A. The non-dairy cheese analog of one or more of examples 1A to 9A, wherein the non-dairy cheese analog is capable of being ground, sliced and/or shredded with minimum matting.

11A. The non-dairy cheese analog of one or more of examples 1A to 10A, wherein the non-dairy cheese analog has suitable mouthfeel.

12A. The non-dairy cheese analog of one or more of examples 1A to 10A, wherein the non-dairy cheese analog after heating maintains a suitable shape and/or stringiness.

13A. The non-dairy cheese analog of one or more of examples 1A to 12A, wherein the non-dairy cheese analog is a substantially non-dairy cheese analog.

14A. The non-dairy cheese analog of one or more of examples 1A to 12A, wherein the non-dairy cheese analog is a non-dairy semi-soft cheese analog.

15A. The non-dairy cheese analog of one or more of examples 1A to 12A, wherein the non-dairy cheese analog is a substantially non-dairy semi-soft cheese analog.

16A. The non-dairy cheese analog of one or more of examples 1A to 12A, wherein the non-dairy cheese analog is a mozzarella non-dairy cheese analog.

17A. The non-dairy cheese analog of one or more of examples 1A to 12A, wherein the non-dairy semi-soft cheese analog is capable of being ground, sliced and/or shredded with minimum matting.

18A. The non-dairy cheese analog of one or more of examples 1A to 12A, wherein the non-dairy cheese analog is blue cheese, colby, fontina, havarti or monterey jack type cheese analog.

19A. The non-dairy cheese analog of one or more of examples 1A to 18A, wherein the non-dairy cheese analog has a cohesiveness of between 0.55 and 1, between 0.6 to 1, between 0.7 and 1, or between 0.7 to 0.9.

20A. The non-dairy cheese analog of one or more of examples 1A to 19A, wherein the non-dairy cheese analog has a cohesiveness of between 0.55 and 1 and a compressibility of between 40% and 100% without rupture or substantial rupture.

21A. The non-dairy cheese analog of one or more of examples 1A to 20A, wherein the non-dairy cheese analog has an average hardness of between 5 Newton and 45 Newton, between 10 Newton to 45 Newton, between 20 Newton to 45 Newton, between 25 Newton to 45 Newton, or between 35 Newton to 45 Newton.

22A. The non-dairy cheese analog of one or more of examples 1A to 21A, wherein the non-dairy cheese analog has an average hardness of between 5 Newton and 45 Newton, between 10 Newton to 45 Newton, between 20 Newton to 45 Newton, between 25 Newton to 45 Newton, or between 35 Newton to 45 Newton.

23A. The non-dairy cheese analog of one or more of examples 1A to 22A, wherein the non-dairy cheese analog has a cohesiveness of between 0.55 and 1, an average hardness of between 5 Newton and 45 Newton and a compressibility of between 40% and 100% without rupture or substantial rupture.

24A. A method for producing the non-dairy cheese analog of one or more of examples 1A to 23A.

25A. The non-dairy cheese analog of one or more of examples 1A to 23A, wherein the non-dairy cheese analog has a compressibility of between 40% and 100% without substantial rupture when tested using the following test parameters: CT3 Texture Analyzer; cylinder same sample 10 mm in length and 12 mm in diameter, sample temperature 4° C., rupture test, stop at load, 0.5 mm/sec test speed, 1 N trigger load and probe TA4/1000.

1B. A non-dairy cheese analog formulation comprising: a high acyl gellan gum gelling component and the non-dairy analog formulation is capable of forming a non-dairy cheese analog with a compressibility of between 40% and 100% without rupture or substantial rupture.

2B. The non-dairy cheese analog formulation of example 1B, wherein the high acyl gellan gum is between 0.2% and 5% by weight of the non-dairy cheese analog formulation.

3B. The non-dairy cheese analog formulation of one or more of examples 1B or 2B, wherein the non-dairy analog formulation is capable of forming a non-dairy cheese analog where the compressibility is greater than 60%, 70% or 80%.

4B. The non-dairy cheese analog formulation of one or more of examples 1B to 3B, wherein the high acyl gellan gum is between 0.8% and 1.2% or 1.4% and 1.6% by weight of the non-dairy cheese analog formulation.

5B. The non-dairy cheese analog formulation of one or more of examples 1B to 4B, wherein the high acyl gellan gum on a percent weight basis of the high acyl gellan gum is at least 80, 90, 95 or 98% high acyl gellan gum.

6B. The non-dairy cheese analog formulation of one or more of examples 1B to 5B, wherein the high acyl gellan gum is a mixture of high acyl gellan gum and low acyl gellan gum.

7B. The non-dairy cheese analog formulation of one or more of examples 1B to 6B, wherein the non-dairy cheese analog formulation further comprises: a) between 8% to 16% by weight of a plant protein; b) between 8% to 18% of a starch; and c) between 8 to 18% by weight of one or more plant oils.

8B. The non-dairy cheese analog formulation of one or more of examples 1B to 7B, wherein the non-dairy cheese analog formulation further comprises: a) between 15% to 30% of a starch; and b) between 10 to 20% by weight of one or more plant oils.

9B. The non-dairy cheese analog formulation of one or more of examples 1B to 8B, wherein the non-dairy cheese analog formulation is capable of forming a non-dairy cheese analog that may be ground, sliced and/or shredded with minimum matting.

10B. The non-dairy cheese analog formulation of one or more of examples 1B to 9B, wherein the non-dairy cheese analog formulation is capable of forming a non-dairy cheese analog that has suitable stringiness and/or mouthfeel.

11B. The non-dairy cheese analog formulation of one or more of examples 1B to 10B, wherein the non-dairy cheese analog formulation is capable of forming a non-dairy cheese analog that after heating maintains a suitable shape and/or stringiness.

12B. The non-dairy cheese analog formulation of one or more of examples 1B to 11B, wherein the non-dairy cheese analog formulation is a substantially non-dairy cheese analog formulation.

13B. The non-dairy cheese analog formulation of one or more of examples 1B to 11B, wherein the non-dairy cheese analog formulation is a non-dairy semi-soft cheese analog formulation.

14B. The non-dairy cheese analog formulation of one or more of examples 1B to 11B, wherein the non-dairy cheese analog formulation is a substantially non-dairy semi-soft cheese analog formulation.

15B. The non-dairy cheese analog formulation of one or more of examples 1B to 11B, wherein the non-dairy cheese analog formulation is a mozzarella non-dairy cheese analog formulation.

16B. The non-dairy cheese analog formulation of one or more of examples 1B to 11B, wherein the non-dairy semi-soft cheese analog that is capable of being ground, sliced and/or shredded with minimum matting.

17B. The non-dairy cheese analog formulation of one or more of examples 1B to 11B, wherein the non-dairy cheese analog formulation is blue cheese, colby, fontina, havarti or monterey jack type cheese analog formulation.

18B. The non-dairy cheese analog formulation of one or more of examples 1B to 17B, wherein the non-dairy cheese analog formulation is capable of forming a non-dairy cheese analog that has a cohesiveness of between 0.55 and 1, between 0.6 to 1, between 0.7 and 1, or between 0.7 to 0.9.

19B. The non-dairy cheese analog formulation of one or more of examples 1B to 18B, wherein the non-dairy cheese analog formulation is capable of forming a non-dairy cheese analog that has a cohesiveness of between 0.55 and 1 and a compressibility of between 40% and 100% without rupture or substantial rupture.

20B. The non-dairy cheese analog formulation of one or more of examples 1B to 19B, wherein the non-dairy cheese analog formulation is capable of forming a non-dairy cheese analog that has an average hardness of between 5 Newton and 45 Newton, between 10 Newton to 45 Newton, between 20 Newton to 45 Newton, between 25 Newton to 45 Newton, or between 35 Newton to 45 Newton.

21B. The non-dairy cheese analog formulation of one or more of examples 1B to 20B, wherein the non-dairy cheese analog formulation is capable of forming a non-dairy cheese analog that has an average hardness of between 5 Newton and 45 Newton, between 10 Newton to 45 Newton, between 20 Newton to 45 Newton, between 25 Newton to 45 Newton, or between 35 Newton to 45 Newton.

22B. The non-dairy cheese analog formulation of one or more of examples 1B to 21B, wherein the non-dairy cheese analog formulation is capable of forming a non-dairy cheese analog that has a cohesiveness of between 0.55 and 1, an average hardness of between 5 Newton and 45 Newton and a compressibility of between 40% and 100% without rupture or substantial rupture.

23B. A method for producing the non-dairy cheese analog formulation of one or more of examples 1B to 21B.

The disclosure has been described with reference to particular embodiments. However, it will be readily apparent to those skilled in the art that it is possible to embody the disclosure in specific forms other than those of the embodiments described above. The embodiments are merely illustrative and should not be considered restrictive. The scope of the disclosure is given by the appended claims, rather than the preceding description, and all variations and equivalents that fall within the range of the claims are intended to be embraced therein.

What is claimed is:

1. A non-dairy cheese analog comprising: a gelling component wherein the non-dairy cheese analog has a compressibility of between 40% and 100% without rupture or substantial rupture.

2. The non-dairy cheese analog of claim 1, wherein the gelling component is a high acyl gellan gum.

3. The non-dairy cheese analog of claim 1 or 2, wherein the high acyl gellan gum is between 0.2% and 5% by weight of the non-dairy cheese analog.

4. The non-dairy cheese analog of one or more of claims 1 to 3, wherein the compressibility is greater than 60%, 70% or 80%.

5. The non-dairy cheese analog of one or more of claims 1 to 4, wherein the high acyl gellan gum is between 0.8% and 1.2% or 1.4% and 1.6% by weight of the non-dairy cheese analog.

6. The non-dairy cheese analog of one or more of claims 1 to 5, wherein the high acyl gellan gum on a percent weight basis of the high acyl gellan gum is at least 80, 90, 95 or 98% high acyl gellan gum.

7. The non-dairy cheese analog of one or more of claims 1 to 6, wherein the high acyl gellan gum is a mixture of high acyl gellan gum and low acyl gellan gum.

8. The non-dairy cheese analog of one or more of claims 1 to 7, wherein the non-dairy cheese analog further comprises: a) between 8% to 16% by weight of a plant protein; b) between 8% to 18% of a starch; and c) between 8 to 18% by weight of one or more plant oils.

9. The non-dairy cheese analog of one or more of claims 1 to 7, wherein the non-dairy cheese analog further comprises: a) between 15% to 30% of a starch; and b) between 10 to 20% by weight of one or more plant oils.

10. The non-dairy cheese analog of one or more of claims 1 to 9, wherein the non-dairy cheese analog is capable of being ground, sliced and/or shredded with minimum matting.

11. The non-dairy cheese analog of one or more of claims 1 to 10, wherein the non-dairy cheese analog has suitable mouthfeel.

12. The non-dairy cheese analog of one or more of claims 1 to 10, wherein the non-dairy cheese analog after heating maintains a suitable shape and/or stringiness.

13. The non-dairy cheese analog of one or more of claims 1 to 12, wherein the non-dairy cheese analog is a substantially non-dairy cheese analog.

14. The non-dairy cheese analog of one or more of claims 1 to 12, wherein the non-dairy cheese analog is a non-dairy semi-soft cheese analog.

15. The non-dairy cheese analog of one or more of claims 1 to 12, wherein the non-dairy cheese analog is a substantially non-dairy semi-soft cheese analog.

16. The non-dairy cheese analog of one or more of claims 1 to 12, wherein the non-dairy cheese analog is a mozzarella non-dairy cheese analog.

17. The non-dairy cheese analog of one or more of claims 1 to 12, wherein the non-dairy semi-soft cheese analog is capable of being ground, sliced and/or shredded with minimum matting.

18. The non-dairy cheese analog of one or more of claims 1 to 12, wherein the non-dairy cheese analog is blue cheese, colby, fontina, havarti or monterey jack type cheese analog.

19. The non-dairy cheese analog of one or more of claims 1 to 18, wherein the non-dairy cheese analog has a cohesiveness of between 0.55 and 1, between 0.6 to 1, between 0.7 and 1, or between 0.7 to 0.9.

20. The non-dairy cheese analog of one or more of claims 1 to 19, wherein the non-dairy cheese analog has a cohesiveness of between 0.55 and 1 and a compressibility of between 40% and 100% without rupture or substantial rupture.

21. The non-dairy cheese analog of one or more of claims 1 to 20, wherein the non-dairy cheese analog has an average hardness of between 5 Newton and 45 Newton, between 10 Newton to 45 Newton, between 20 Newton to 45 Newton, between 25 Newton to 45 Newton, or between 35 Newton to 45 Newton.

22. The non-dairy cheese analog of one or more of claims 1 to 21, wherein the non-dairy cheese analog has an average hardness of between 5 Newton and 45 Newton, between 10 Newton to 45 Newton, between 20 Newton to 45 Newton, between 25 Newton to 45 Newton, or between 35 Newton to 45 Newton.

23. The non-dairy cheese analog of one or more of claims 1 to 22, wherein the non-dairy cheese analog has a cohesiveness of between 0.55 and 1, an average hardness of between 5 Newton and 45 Newton and a compressibility of between 40% and 100% without rupture or substantial rupture.

24. A method for producing the non-dairy cheese analog of one or more of claims 1 to 23.
